(19) United States
(12) Patent Application Publication
(10) Pub. No.: US 2021/0294018 A1
(43) Pub. Date: Sep. 23, 2021

(54) DISPLAY DEVICE AND HEAD-MOUNTED DISPLAY

(71) Applicant: SHARP KABUSHIKI KAISHA, Osaka (JP)

(72) Inventors: YUUICHI KANBAYASHI, Osaka (JP); SHUGO YAGI, Osaka (JP); SATOSHI TSUBOOKA, Osaka (JP)

(21) Appl. No.: 17/200,541

(22) Filed: Mar. 12, 2021

(30) Foreign Application Priority Data
Mar. 19, 2020 (JP) 2020-049366

(51) Int. Cl. F21V 8/00; G06T 11/00; G06F 1/16

(52) U.S. Cl. CPC G02B 6/0053; G06F 1/163; G02B 6/0038; G06T 11/00

(57) ABSTRACT

A display device includes a light source, a light guide plate having a light entering end surface and a light emitting plate surface, a display panel, and a lens sheet. A prism unit of the lens sheet has a plurality of unit prisms having a top portion and a pair of slopes, the plurality of unit prisms have at least a plurality of top portion uneven distribution prisms, and the plurality of top portion uneven distribution prisms have a light-source-end-side top portion uneven distribution prism positioned on a light source end side in the normal direction and an opposite-light-source-end-side top portion uneven distribution prism positioned on an opposite light source end side in the normal direction and arranged such that a distance from the opposite light source end is the same as a distance from the light source end to the light-source-end-side top portion uneven distribution prism.

### BACKGROUND

### 1. Field

The present disclosure relates to a display device and a head-mounted display.

### 2. Description of the Related Art

In the related art, a technique described in Japanese Unexamined Patent Application Publication No. 2013-37260 below is known as an example of a virtual image display device. In the virtual image display device described in Japanese Unexamined Patent Application Publication No. 2013-37260, since an optical directivity changing unit forms a non-uniform distribution with respect to the directivity of image light emitted from an image display device, even in a case where the angle of the luminous flux emitted from the image display device and effectively captured by the eyes of the observer differs greatly depending on the position of the image display device, it is possible to form image light having directivity corresponding to such an angular characteristic of light flux capture, and to suppress the occurrence of luminance spots and improve the utilization efficiency of illumination light.

The virtual image display device described in Japanese Unexamined Patent Application Publication No. 2013-37260 described above has a configuration in which an optical directivity changing unit is attached to an injection surface of a backlight guide unit. On the other hand, there is a case where a configuration in which a lens sheet is disposed on the injection surface of the backlight guide unit and a prism unit is provided on a light entering surface of the lens sheet is employed. In this manner, it is possible to efficiently refract the light emitted from the backlight guide unit by the prism unit provided on the light entering surface to improve the front luminance. However, when the lens sheet described above is used, the front luminance is improved, but there is a concern that the luminance uniformity deteriorates.

The technique described in the specification of the present application has been completed based on the above-described circumstances, and it is desirable to improve the luminance uniformity.

### SUMMARY

According to an aspect of the disclosure, there is provided a display device including: a light source; a light guide plate having a light entering end surface which is at least a part of an outer peripheral end surface and on which light from the light source is incident and a light emitting plate surface which is one of a pair of plate surfaces and emits light; a display panel arranged so as to face the light emitting plate surface with respect to the light guide plate; and a lens sheet that is arranged so as to be interposed between the light guide plate and the display panel and refracts the light emitted from the light emitting plate surface, in which the lens sheet has a prism unit arranged on a light entering surface facing the light emitting plate surface, and the prism unit has a plurality of unit prisms arranged along a normal direction of the light entering end surface, extending along the light emitting plate surface and along an orthogonal direction orthogonal to the normal direction, and having a top portion and a pair of slopes sandwiching the top portion, and the plurality of unit prisms have at least a plurality of top portion uneven distribution prisms in which the top portions are unevenly distributed in the normal direction, and the plurality of top portion uneven distribution prisms have a light-source-end-side top portion uneven distribution prism positioned on a light source end side close to the light source in the normal direction and an opposite-light-source-end-side top portion uneven distribution prism which is positioned on an opposite light source end side on an opposite side of a light source end in the normal direction, is arranged such that a distance from an opposite light source end is the same as a distance from the light source end to the light-source-end-side top portion uneven distribution prism, and has a different uneven distribution amount of the top portions from that of the light-source-end-side top portion uneven distribution prism.

According to another aspect of the disclosure, there is provided a head-mounted display including: the display device according to the above-described aspect; a lens unit that forms an image displayed on the display device on an eye of a user; and a head-mounted device having the display device and the lens unit and mounted on a head of the user.

### BRIEF DESCRIPTION OF THE DRAWINGS

FIG. 1 is a schematic perspective view illustrating a state where a user wears a head-mounted display according to Embodiment 1 on the head;

FIG. 2 is a schematic side view illustrating an optical relationship between a liquid crystal display device and a lens unit provided in a head-mounted device that configures the head-mounted display, and an eyeball of the user;

FIG. 3 is an exploded perspective view of a backlight device provided in a liquid crystal display device;

FIG. 4 is a sectional view of a liquid crystal display device cut along a long-side direction;

FIG. 5 is a sectional view of the liquid crystal display device cut along a short-side direction;

FIG. 6 is a sectional view of a first lens sheet;

FIG. 7 is a graph illustrating a relationship between a difference between a base angle on an LED end side and a reference value in a first unit prism and a position in a Y-axis direction;

FIG. 8 is a sectional view of a second lens sheet;

FIG. 9 is a graph illustrating a relationship between base angles on each end side of a second unit prism and a position in an X-axis direction;

FIG. 10 is a graph illustrating a luminance angle distribution in the Y-axis direction at measurement points P1 according to Example 1 and Comparative Example of Comparative Experiment 1;

FIG. 11 is a graph illustrating a luminance angle distribution in the Y-axis direction at measurement points P2 according to Example 1 and Comparative Example of Comparative Experiment 1;

FIG. 12 is a graph illustrating a luminance angle distribution in the Y-axis direction at measurement points P3 according to Example 1 and Comparative Example of Comparative Experiment 1;

FIG. 13 is a graph illustrating a luminance angle distribution in the X-axis direction at measurement points P1 according to Example 1 and Comparative Example of Comparative Experiment 1;

FIG. 14 is a graph illustrating a luminance angle distribution in the X-axis direction at measurement points P4 according to Example 1 and Comparative Example of Comparative Experiment 1;

FIG. 15 is a graph illustrating a luminance angle distribution in the X-axis direction at measurement points P5 according to Example 1 and Comparative Example of Comparative Experiment 1;

FIG. 16 is a table illustrating experimental results according to Comparative Experiment 2;

FIG. 17 is a sectional view of a liquid crystal display device according to Embodiment 2 cut along the short-side direction;

FIG. 18 is a graph illustrating a luminance angle distribution in the Y-axis direction at measurement points P1 according to Example 4 and Comparative Example of Comparative Experiment 3;

FIG. 19 is a graph illustrating a luminance angle distribution in the Y-axis direction at measurement points P2 according to Example 4 and Comparative Example of Comparative Experiment 3;

FIG. 20 is a graph illustrating a luminance angle distribution in the Y-axis direction at measurement points P3 according to Example 4 and Comparative Example of Comparative Experiment 3;

FIG. 21 is a graph illustrating a luminance angle distribution in the X-axis direction at measurement points P1 according to Example 4 and Comparative Example of Comparative Experiment 3;

FIG. 22 is a graph illustrating a luminance angle distribution in the X-axis direction at measurement points P4 according to Example 4 and Comparative Example of Comparative Experiment 3;

FIG. 23 is a graph illustrating a luminance angle distribution in the X-axis direction at measurement points P5 according to Example 4 and Comparative Example of Comparative Experiment 3;

FIG. 24 is a graph illustrating a luminance angle distribution in the Y-axis direction at measurement points P1 according to Example 1 and Example 4 of Comparative Experiment 4;

FIG. 25 is a graph illustrating a luminance angle distribution in the X-axis direction at measurement points P1 according to Example 1 and Example 4 of Comparative Experiment 4;

FIG. 26 is a perspective view of a light guide plate that configures a backlight device provided in a liquid crystal display device according to Embodiment 3;

FIG. 27 is a sectional view of the liquid crystal display device cut along the short-side direction in the vicinity of the LED end;

FIG. 28 is a sectional view of the liquid crystal display device cut along the short-side direction in the vicinity of a center;

FIG. 29 is a sectional view of the liquid crystal display device cut along the short-side direction in the vicinity of an opposite LED end;

FIG. 30 is a graph illustrating a luminance angle distribution in the Y-axis direction at measurement points P1 according to Example 5 and Comparative Example of Comparative Experiment 5;

FIG. 31 is a graph illustrating a luminance angle distribution in the Y-axis direction at measurement points P2 according to Example 5 and Comparative Example of Comparative Experiment 5;

FIG. 32 is a graph illustrating a luminance angle distribution in the Y-axis direction at measurement points P3 according to Example 5 and Comparative Example of Comparative Experiment 5;

FIG. 33 is a graph illustrating a luminance angle distribution in the X-axis direction at measurement points P1 according to Example 5 and Comparative Example of Comparative Experiment 5;

FIG. 34 is a graph illustrating a luminance angle distribution in the X-axis direction at measurement points P4 according to Example 5 and Comparative Example of Comparative Experiment 5;

FIG. 35 is a graph illustrating a luminance angle distribution in the X-axis direction at measurement points P5 according to Example 5 and Comparative Example of Comparative Experiment 5;

FIG. 36 is a graph illustrating a luminance angle distribution in the Y-axis direction at measurement points P1 according to Example 1 and Example 5 of Comparative Experiment 6;

FIG. 37 is a graph illustrating a luminance angle distribution in the X-axis direction at measurement points P1 according to Example 1 and Example 5 of Comparative Experiment 6;

FIG. 38 is a sectional view of a liquid crystal display device according to Embodiment 4 cut along the short-side direction;

FIG. 39 is a graph illustrating a luminance angle distribution in the Y-axis direction at measurement points P1 according to Example 6 and Comparative Example of Comparative Experiment 7;

FIG. 40 is a graph illustrating a luminance angle distribution in the Y-axis direction at measurement points P2 according to Example 6 and Comparative Example of Comparative Experiment 7;

FIG. 41 is a graph illustrating a luminance angle distribution in the Y-axis direction at measurement points P3 according to Example 6 and Comparative Example of Comparative Experiment 7;

FIG. 42 is a graph illustrating a luminance angle distribution in the X-axis direction at measurement points P1 according to Example 6 and Comparative Example of Comparative Experiment 7;

FIG. 43 is a graph illustrating a luminance angle distribution in the X-axis direction at measurement points P4 according to Example 6 and Comparative Example of Comparative Experiment 7;

FIG. 44 is a graph illustrating a luminance angle distribution in the X-axis direction at measurement points P5 according to Example 6 and Comparative Example of Comparative Experiment 7;

FIG. 45 is a sectional view of a liquid crystal display device according to Embodiment 5 cut along the short-side direction;

FIG. 46 is a graph illustrating a luminance angle distribution in the Y-axis direction at measurement points P1 according to Example 7 and Comparative Example of Comparative Experiment 8;

FIG. 47 is a graph illustrating a luminance angle distribution in the Y-axis direction at measurement points P2 according to Example 7 and Comparative Example of Comparative Experiment 8;

FIG. 48 is a graph illustrating a luminance angle distribution in the Y-axis direction at measurement points P3 according to Example 7 and Comparative Example of Comparative Experiment 8;

FIG. 49 is a graph illustrating a luminance angle distribution in the X-axis direction at measurement points P1 according to Example 7 and Comparative Example of Comparative Experiment 8;

FIG. 50 is a graph illustrating a luminance angle distribution in the X-axis direction at measurement points P4 according to Example 7 and Comparative Example of Comparative Experiment 8;

FIG. 51 is a graph illustrating a luminance angle distribution in the X-axis direction at measurement points P5 according to Example 7 and Comparative Example of Comparative Experiment 8;

FIG. 52 is a schematic side view illustrating an optical relationship between a liquid crystal display device and a lens unit provided in a head-mounted device that configures a head-mounted display according to Embodiment 6, and the eyeball of the user;

FIG. 53 is a sectional view of the first lens sheet;

FIG. 54 is a graph illustrating a relationship between the difference between the base angle on the LED end side and the reference value in the first unit prism and the position in the Y-axis direction;

FIG. 55 is a sectional view of a second lens sheet according to Embodiment 7;

FIG. 56 is a graph illustrating a relationship between a base angle on a center side in the second unit prism and the position in the X-axis direction;

FIG. 57 is a graph illustrating a relationship between a difference between the reference value and a base angle on an LED end side in a first unit prism provided in a first lens sheet according to another Embodiment (1) and the position in the Y-axis direction; and

FIG. 58 is a graph illustrating a relationship between a difference between base angles on each end side in a second unit prism provided in a second lens sheet according to another Embodiment (2) and the position in the X-axis direction.

### DESCRIPTION OF THE EMBODIMENTS

### Embodiment 1

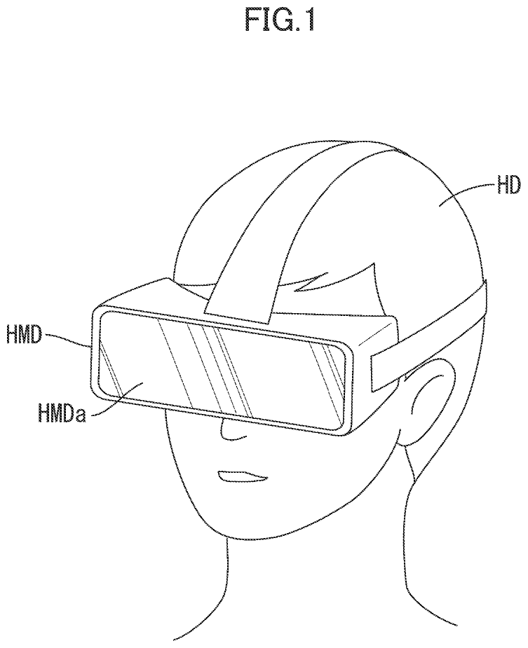

Embodiment 1 will be described with reference to FIGS. 1 to 16. In the embodiment, a goggle-type head-mounted display HMD and a liquid crystal display device 10 used therefor are exemplified. An X-axis, a Y-axis, and a Z-axis are illustrated at a part of each drawing, and each axis direction is drawn so as to be the directions illustrated in each drawing.

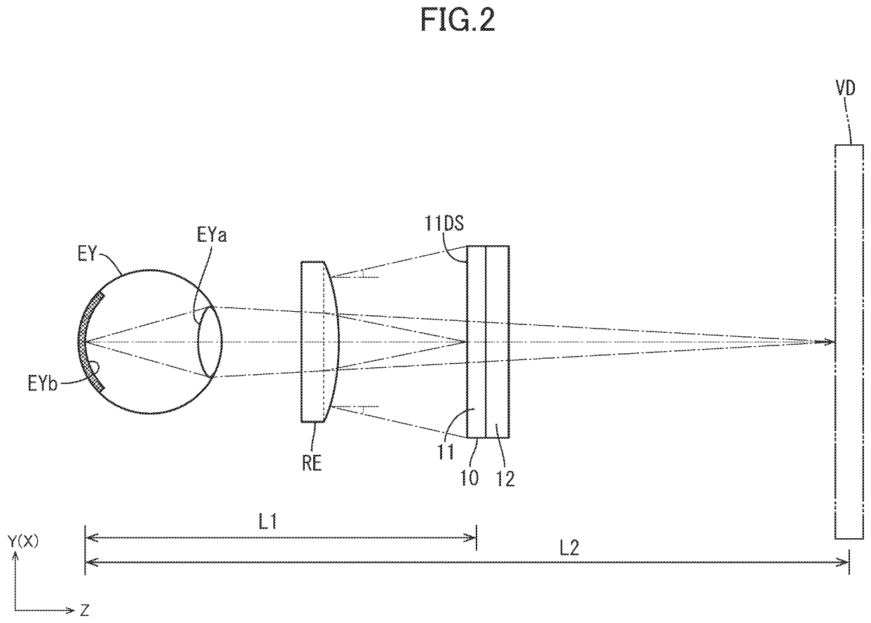

As illustrated in FIG. 1, the goggle-type head-mounted display HMD includes a head-mounted device HMDa that is mounted so as to surround both eyes in a head HD of a user. As illustrated in FIG. 2, in the head-mounted device HMDa, at least the liquid crystal display device 10 for displaying an image and a lens unit RE for forming an image displayed on the liquid crystal display device 10 on an eyeball EY of the user are built in. The liquid crystal display device 10 includes at least a liquid crystal panel 11 and a backlight device 12 that irradiates the liquid crystal panel 11 with light. The liquid crystal panel 11 is a “display panel”, and the backlight device 12 is a “illumination device”. The lens unit RE is arranged so as to be interposed between the liquid crystal display device 10 and the eyeball EY of the user, and imparts a refraction action to the transmitted light. By adjusting the focal length of the lens unit RE, it is possible to make the user recognize that the image formed on a retina EYb via a crystalline lens EYa of the eyeball EY is displayed on a virtual display VD that apparently exists at a distance L2 much farther than an actual distance L1 from the eyeball EY to the liquid crystal display device 10. Accordingly, the user visually recognize an enlarged image which is a virtual image displayed on the virtual display VD having a screen size (for example, approximately several tens of inches to several hundred inches) that is much larger than a screen size (for example, approximately zero point several inches to several inches) of the liquid crystal display device 10. The eyeball EY, the crystalline lens EYa, and the retina EYb are “eyes”.

As illustrated in FIG. 2, the lens unit RE according to the embodiment has an optical design in which the light that advances at an angle tilted outward (toward the end side on the opposite side of the center side in the X-axis direction and the Y-axis direction) with respect to a Z-axis direction which is a normal direction of a display surface 11DS of the liquid crystal panel 11 is captured, and angled so as to be oriented toward the eye of the user. Therefore, in the embodiment, it is preferable that the emitted light of the liquid crystal panel 11 is angled so as to be directed inward (toward the center side in the X-axis direction and the Y-axis direction) of the lens unit RE. There is a preferable numerical value for the angle formed by the light captured by the lens unit RE with respect to the Z-axis direction, and in the embodiment, the angle is, for example, approximately ±20°. In other words, the light that forms an angle of ±20° on the outside with respect to the Z-axis direction is efficiently captured by the lens unit RE and efficiently reaches the eye of the user. It is also possible to mount one liquid crystal display device 10 on the head-mounted device HMDa and display an image for the right eye and an image for the left eye on the liquid crystal display device 10, but it is also possible to mount two liquid crystal display devices 10 on the head-mounted device HMDa, and to display an image for the right eye on one liquid crystal display device 10 and an image for the left eye on the other liquid crystal display device 10, respectively. The head-mounted device HMDa is also provided with earphones or the like that are addressed to the ear of the user and emit a sound.

The liquid crystal panel 11 and the backlight device 12 that configure the liquid crystal display device 10 will be described in order. As illustrated in FIG. 2, the liquid crystal panel 11 has a rectangular plate shape as a whole, and the plate surface on the lens unit RE side is the display surface 11DS for displaying an image. The liquid crystal panel 11 includes at least one pair of glass substrates bonded to each other with a predetermined gap therebetween, and a liquid crystal layer containing liquid crystal molecules that are substances which are sealed between both substrates and of which optical characteristics change according to the application of an electric field. On one substrate, a switching element connected to a source wiring and a gate wiring orthogonal to each other, and a pixel electrode arranged in a rectangular region surrounded by the source wiring and the gate wiring and connected to a switching element, are disposed in a plane in a matrix, and additionally, an alignment film or the like is provided. One substrate is an “array substrate” or an “active matrix substrate”. The switching element is, for example, a TFT or the like. On the other substrate, a color filter in which each colored portion such as R (red), G (green), and B (blue) is arranged in a plane in a matrix in a predetermined arrangement is provided, and additionally, a light shielding layer that is arranged between each colored portions and makes a grid, a solid counter electrode that faces the pixel electrode, an alignment film, and the like are provided. The other substrate is “counter substrate” or “CF substrate”, and the light shielding layer is “black matrix”. Polarizing plates are arranged respectively on the outsides of both substrate.

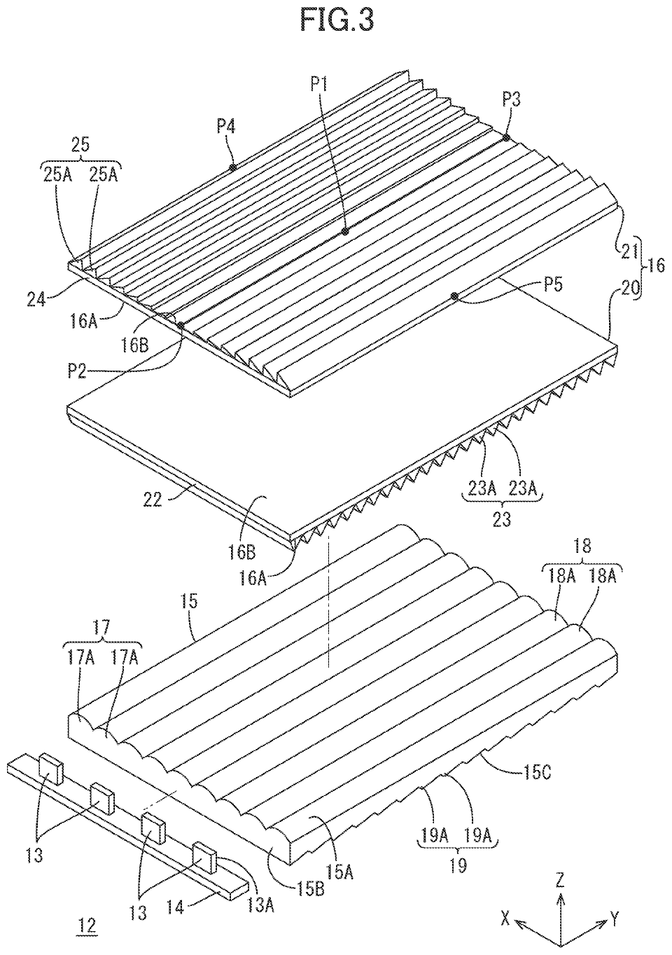

Subsequently, the backlight device 12 will be described. As illustrated in FIG. 3, the backlight device 12 includes at least an LED 13, an LED substrate 14 on which the LED 13 is mounted, a light guide plate 15 that guides the light from the LED 13, and a plurality of optical sheets 16 arranged so as to be interposed between the light guide plate 15 and the liquid crystal panel 11. The LED 13 is a “light source” and the LED substrate 14 is a “light source substrate”. The backlight device 12 is a one-sided light entering type edge light type in which the light of the LED 13 is input to the light guide plate 15 from only one side. The backlight device 12 may include a reflective sheet arranged on the back side of the light guide plate 15 to reflect light.

As illustrated in FIG. 3, the LED 13 has a configuration in which an LED chip is sealed with a sealing material on a substrate unit fixed to the LED substrate 14. In the LED 13, for example, the LED chip is assumed to emit blue light in a single color, and to emit white light as a whole by dispersing and blending the phosphor in the sealing material. The phosphor includes a yellow phosphor, a green phosphor, a red phosphor and the like. The LED 13 is a so-called side light emitting type in which a surface adjacent to a mounting surface with respect to the LED substrate 14 is a light emitting surface 13A. The LED substrate 14 is installed in a posture in which the plate surface thereof is parallel to the plate surface of the light guide plate 15, and the plate surface facing the back side is used as the mounting surface of the LED 13, and a plurality of LEDs 13 are mounted so as to be aligned at intervals along the X-axis direction on the same mounting surface.

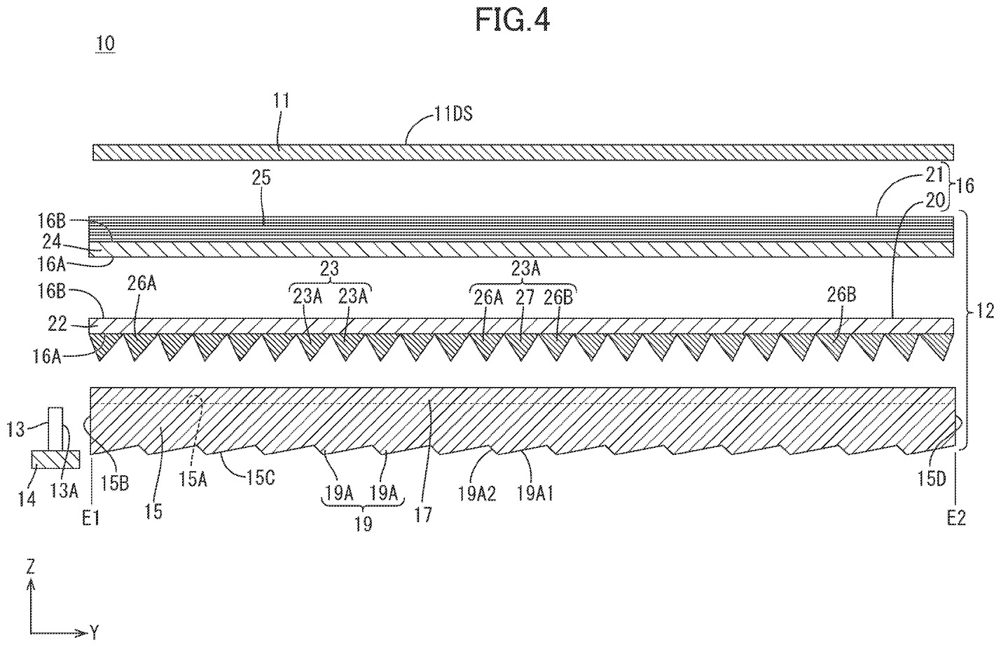

The light guide plate 15 is made of a synthetic resin material (for example, acrylic resin such as PMMA) having a refractive index sufficiently higher than that of air and being substantially transparent. As illustrated in FIGS. 3 and 4, the light guide plate 15 has a flat plate shape, and the plate surface thereof is parallel to the plate surface of the liquid crystal panel 11, that is, the display surface 11DS. The light guide plate 15 has a long-side direction on the plate surface that coincides with the Y-axis direction in each drawing and a short-side direction that coincides with the X-axis direction, respectively, and a plate thickness direction that is orthogonal to the plate surface that coincides with the Z-axis direction. Of the pair of plate surfaces in the light guide plate 15, the plate surface facing the liquid crystal panel 11 and the optical sheet 16 is the light emitting plate surface 15A that emits light that has guided on the inside. As illustrated in FIG. 4, the light guide plate 15 is arranged immediately below the liquid crystal panel 11 and the optical sheet 16, and the end surface on one short side among the outer peripheral end surfaces faces the light emitting surface 13A of the LED 13 and is a light entering end surface 15B into which the light from the light emitting surface 13A is incident. The light guide plate 15 has a function of introducing the light emitted from the LED 13 toward the light guide plate 15 in the Y-axis direction, that is, along the alignment direction of the LED 13 and the light guide plate 15 from the light entering end surface 15B, and propagating the light internally and then raising the light from the light emitting plate surface 15A toward the front side to emit the light. The end surface on another short side among the outer peripheral end surfaces of the light guide plate 15, that is, the end surface on the opposite side of the light entering end surface 15B is referred to as a light entering opposite end surface 15D. The normal direction of the light entering end surface 15B (light entering opposite end surface 15D) coincides with the Y-axis direction, and the orthogonal direction which is along the light emitting plate surface 15A and orthogonal to the normal direction of the light entering end surface 15B coincides with the X-axis direction, respectively. The normal direction of the light entering end surface 15B substantially coincides with the optical axis (the advancing direction of the light having the strongest light emission intensity) in the LED 13.

As illustrated in FIG. 3, the light emitting plate surface 15A of the light guide plate 15 is provided with a light emitting plate surface lens unit 17. The light emitting plate surface lens unit 17 has a plurality of light emitting plate surface unit lenses 17A extending along the Y-axis direction (normal direction of the light entering end surface 15B) and arranged along the X-axis direction (orthogonal direction). Specifically, the light emitting plate surface lens unit 17 is a light emitting plate surface lenticular lens 18 in which the plurality of light emitting plate surface unit lenses 17A are configured with a plurality of light emitting plate surface cylindrical lenses 18A. The light emitting plate surface lenticular lens 18 is a convex lens in which each light emitting plate surface cylindrical lens 18A protrudes from the light emitting plate surface 15A toward the front side. The light emitting plate surface cylindrical lens 18A has a substantially semi-cylindrical shape of which the axial direction coincides with the Y-axis direction, and has a convex arcuate surface 18A1 of which the front surface that faces the front side thereof has an arc shape. The light emitting plate surface cylindrical lens 18A has a substantially semicircular section cut along the X-axis direction orthogonal to the axial direction thereof. When an angle θt formed by a tangent line Ta at the base end portion of the arcuate surface 18A1 with respect to the X-axis direction is defined as “tangent angle”, the light emitting plate surface cylindrical lens 18A has a tangent angle θt of, for example, approximately 40°, but the disclosure is not necessarily limited thereto. All of the plurality of light emitting plate surface cylindrical lenses 18A arranged along the X-axis direction have substantially the same tangent angle θt and the width dimension and the height dimension of the bottom surface, and are arranged at substantially certain intervals with the arrangement interval between the adjacent light emitting plate surface cylindrical lenses 18A. According to such a configuration, when the light that propagates in the light guide plate 15 reaches the light emitting plate surface 15A, the light is reflected by the plurality of light emitting plate surface cylindrical lenses 18A that configure the light emitting plate surface lenticular lens 18, and accordingly, the spread in the X-axis direction is limited. Accordingly, unevenness of light and darkness is less likely to occur between the vicinity of the LED 13 and the neighbor thereof in the X-axis direction. Moreover, the light emitting plate surface cylindrical lens 18A is more likely to be diffused in the X-axis direction when the light that propagates in the light guide plate 15 is reflected than the prism, and thus, the luminance uniformity is higher.

Of the pair of plate surfaces of the light guide plate 15, on the light emitting opposite plate surface 15C on the opposite side of the light emitting plate surface 15A, as illustrated in FIG. 3, an emitted-light reflection unit 19 that reflects the light propagating in the light guide plate 15 for promoting the emission from the light emitting plate surface 15A is provided. The emitted-light reflection unit 19 extends along the X-axis direction on the light emitting opposite plate surface 15C of the light guide plate 15, and a plurality of groove-shaped unit reflection units 19A having a substantially triangular sectional shape are arranged along the Y-axis direction. The unit reflection unit 19A is “prism”. The unit reflection unit 19A has a pair of slopes 19A1 and 19A2 with a top portion sandwiched in the Y-axis direction, and while one slope arranged on the light entering opposite end surface 15D side (opposite side of the LED 13 side) of the pair of slopes 19A1 and 19A2 is the main reflection slope 19A1, the slope arranged on the light entering end surface 15B side (LED 13 side) is the re-incident slope 19A2. The main reflection slope 19A1 is an inclined surface having an upslope so as to gradually approach the light emitting plate surface 15A as going toward the opposite side of the LED 13 side in the Y-axis direction. The re-incident slope 19A2 is an inclined surface having a downslope so as to gradually move away from the light emitting plate surface 15A as going toward the opposite side of the LED 13 side in the Y-axis direction. The unit reflection unit 19A reflects light on the main reflection slope 19A1 to generate light of which the incident angle with respect to the light emitting plate surface 15A does not exceed the critical angle, and promotes the emission from the light emitting plate surface 15A. On the other hand, on the re-incident slope 19A2, the transmitted light re-enters into the light guide plate 15 when the light of which the incident angle with respect to the main reflection slope 19A1 does not exceed the critical angle passes through the main reflection slope 19A1. In the embodiment, the inclination angle formed by the main reflection slope 19A1 with respect to the Y-axis direction is, for example, approximately 1.2°, but the disclosure is not necessarily limited thereto.

As illustrated in FIG. 3, the optical sheet 16 has a sheet shape, and the plate surface thereof is parallel to each plate surface of the liquid crystal panel 11 and the light guide plate 15. The optical sheet 16 is arranged to be interposed between the liquid crystal panel 11 and the light guide plate 15 in the Z-axis direction, and has a function of emitting light toward the liquid crystal panel 11 while imparting a predetermined optical action to the light emitted from the LED 13. In the optical sheet 16, while the back side, that is, the plate surface facing the light emitting plate surface 15A side of the light guide plate 15 is a light entering surface 16A into which light is enters, the front side, that is, the plate surface facing the display surface 11DS side of the liquid crystal panel 11 is a light emitting surface 16B that emits the light. The optical sheet 16 has a total of two lens sheets, such as a first lens sheet (lens sheet, light-guide-plate-side lens sheet) 20 and a second lens sheet (second lens sheet, display-panel-side lens sheet) 21 in the order from the back side. The configurations of the first lens sheet 20 and the second lens sheet 21 will be sequentially described.

As illustrated in FIG. 4, the first lens sheet 20 is arranged at a position interposed between the light guide plate 15 and the second lens sheet 21 in the Z-axis direction. The first lens sheet 20 is configured with a first base material 22 made of a substantially transparent synthetic resin and a first prism unit (prism unit) 23 provided on a plate surface of the first base material 22 facing the light guide plate 15, that is, the light entering surface 16A. The first prism unit 23 is configured with a plurality of first unit prisms (unit prisms) 23A protruding from the light entering surface 16A of the first base material 22 toward the back side (light guide plate 15 side) along the Z-axis direction. The first unit prism 23A has a substantially chevron-shaped section cut along the Y-axis direction and extends linearly along the X-axis direction, and the plurality of first unit prisms 23A are arranged side by side along the Y-axis direction on the light entering surface 16A. Each first unit prism 23A has a pair of first slopes (slopes) 23A2 and 23A3 with the first top portion (top portion) 23A1 interposed therebetween in the Y-axis direction. Of the pair of first slopes 23A2 and 23A3, the one positioned on the opposite side of the LED 13 side in the Y-axis direction with respect to the first top portion 23A1 is the main refraction slope 23A2, and the other one positioned on the LED 13 side in the Y-axis direction with respect to the first top portion 23A1 is the light entering slope 23A3. When the light is incident on the first unit prism 23A having such a configuration from the light guide plate 15 side, by refracting the light on the interface between each of the first slopes 23A2 and 23A3 and the external air layer, and accordingly, the light is raised in the Z-axis direction (front direction). Specifically, since the light that propagates in the light guide plate 15 is emitted from the light emitting plate surface 15A in the process of advancing toward the side away from the LED 13 in the Y-axis direction, after the emitted light is incident on the light entering slope 23A3 of the pair of first slopes 23A2 and 23A3 in the first unit prism 23A that configures the first prism unit 23, the refraction action is mainly imparted by the main refraction slope 23A2. Although such a light condensing action acts on the light incident on the first unit prism 23A along the Y-axis direction, it is assumed that there is almost no effect on the light incident along the X-axis direction orthogonal to the Y-axis direction. Therefore, it can be said that, while the Y-axis direction, which is the arrangement direction of the plurality of first unit prisms 23A, is the light condensing direction in which the light condensing action is imparted to the light, the X-axis direction, which is the extending direction of each first unit prism 23A, is a non-light condensing direction in which the light condensing action is almost not imparted to the light, and the first prism unit 23 according to the embodiment has an anisotropy light condensing function.

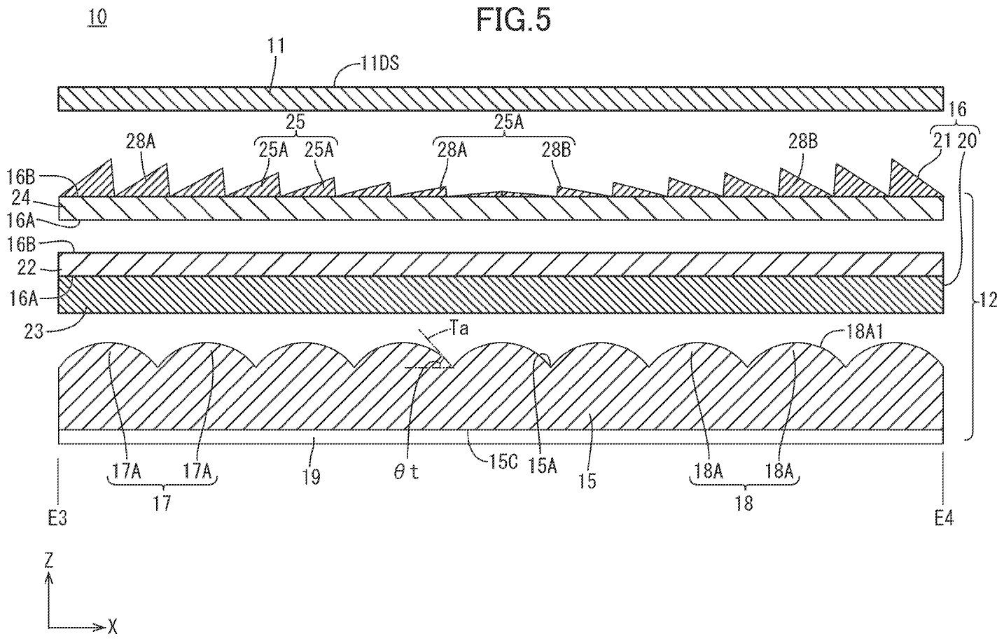

As illustrated in FIG. 5, the second lens sheet 21 is arranged at a position interposed between the liquid crystal panel 11 and the first lens sheet 20 in the Z-axis direction. The second lens sheet 21 is configured with a second base material 24 made of a substantially transparent synthetic resin and a second prism unit (second prism unit) 25 provided on a plate surface of the second base material 24 facing the liquid crystal panel 11, that is, the light emitting surface 16B. The second prism unit 25 is configured with a plurality of second unit prisms (second unit prisms) 25A protruding from the light emitting surface 16B of the second base material 24 toward the front side (liquid crystal panel 11 side) along the Z-axis direction. The second unit prism 25A has a substantially chevron-shaped section cut along the X-axis direction and extends linearly along the Y-axis direction, and the plurality of second unit prisms 25A are arranged side by side along the X-axis direction on the light emitting surface 16B. Each second unit prism 25A has a pair of second slopes (second slopes) 25A2 and 25A3 with a second top portion (second top portion) 25A1 interposed therebetween in the X-axis direction. When the light is incident on the second unit prism 25A side having such a configuration from the first lens sheet 20 side, by refracting the light on the interface between each of the second slopes 25A2 and 25A3 and the external air layer, and accordingly, the light is raised in the Z-axis direction (front direction). Although such a light condensing action acts on the light incident on the second unit prism 25A along the X-axis direction, it is assumed that there is almost no effect on the light incident along the Y-axis direction orthogonal to the X-axis direction. Therefore, it can be said that, while the X-axis direction, which is the arrangement direction of the plurality of second unit prisms 25A, is the light condensing direction in which the light condensing action is imparted to the light, the Y-axis direction, which is the extending direction of each second unit prism 25A, is a non-light condensing direction in which the light condensing action is almost not imparted to the light, the second prism unit 25 according to the embodiment has an anisotropy light condensing function.

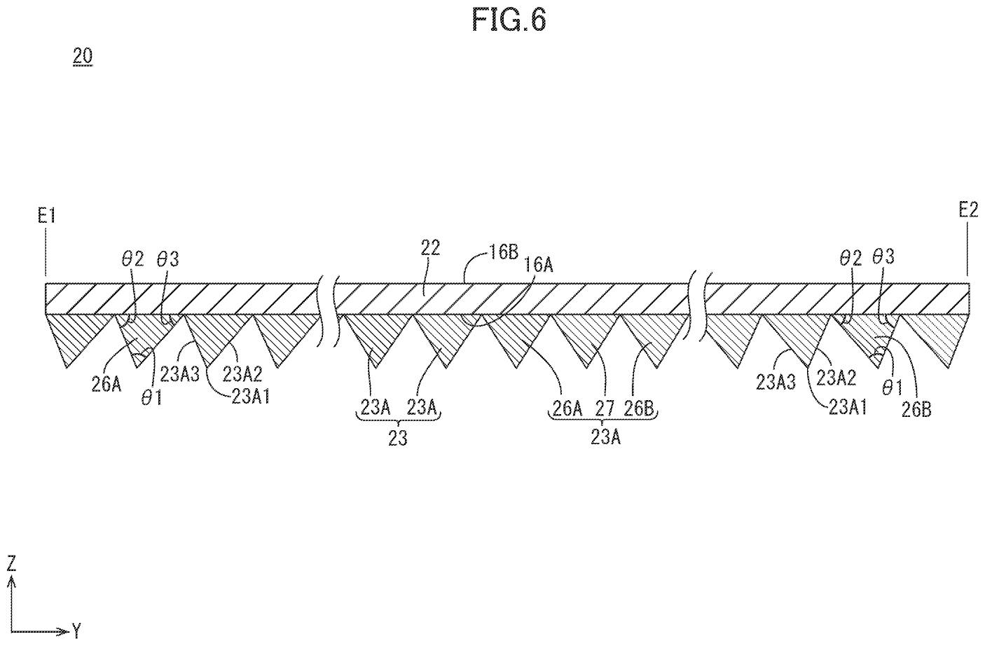

As illustrated in FIG. 6, the first prism unit 23 provided in the first lens sheet 20 having the above-described configuration includes a first top portion uneven distribution prism 26 in which the first top portions 23A1 are unevenly distributed in the Y-axis direction, and a top portion non-uneven distribution prism 27 in which the first top portions 23A1 are not evenly distributed in the Y-axis direction, on the plurality of first unit prisms 23A. According to such a configuration, by adjusting the uneven distribution amount or the like of the first top portion 23A1 in the first top portion uneven distribution prism 26 included in the plurality of first unit prisms 23A, it is possible to easily control the refraction action imparted to the light by the main refraction slope 23A2 on an opposite LED end E2 side. At least one of the top portion non-uneven distribution prisms 27 is arranged in the vicinity (specifically, a position on the opposite side of the LED 13 side from the center position) of the center in the Y-axis direction in the first lens sheet 20. The top portion non-uneven distribution prism 27 has the first top portions 23A1 arranged at the center position in the Y-axis direction, and has an isosceles triangular shape. On the other hand, in the first top portion uneven distribution prism 26, the first top portion 23A1 is displaced to either one side from the center position in the Y-axis direction. A plurality of first top portion uneven distribution prisms 26 are arranged one by one on both ends E1 and E2 sides in the Y-axis direction with respect to the top portion non-uneven distribution prism 27 in the first lens sheet 20. Here, both ends E1 and E2 in the Y-axis direction of the first lens sheet 20 include the LED end (light source end) E1 near the LED 13 (light entering end surface 15B) and the opposite LED end (opposite light source end) E2 far from the LED 13 (close to the light entering opposite end surface 15D). The first top portion uneven distribution prism 26 includes an LED-end-side first top portion uneven distribution prism (light-source-end-side top portion uneven distribution prism) 26A positioned on the LED end E1 side of the top portion non-uneven distribution prism 27 in the Y-axis direction, and an opposite-LED-end-side first top portion uneven distribution prism (opposite-light-source-end-side top portion uneven distribution prism) 26B positioned on the opposite LED end E2 side of the top portion non-uneven distribution prism 27 in the Y-axis direction.

As illustrated in FIG. 6, in any of the first top portion uneven distribution prisms 26 according to the embodiment, the first top portions 23A1 are unevenly distributed on both ends E1 and E2 sides in the Y-axis direction. Specifically, the plurality of LED-end-side first top portion uneven distribution prisms 26A are arranged in a range from the top portion non-uneven distribution prism 27 to the LED end E1 in the Y-axis direction in the first lens sheet 20, and the first top portions 23A1 are unevenly distributed on the LED end E1 side in the Y-axis direction. On the other hand, the plurality of opposite-LED-end-side first top portion uneven distribution prisms 26B are arranged in a range from the top portion non-uneven distribution prism 27 to the opposite LED end E2 in the Y-axis direction in the first lens sheet 20, and the first top portions 23A1 are unevenly distributed on the opposite LED end E2 side in the Y-axis direction. According to such a configuration, any light refracted by the main refraction slope 23A2 on the opposite LED end E2 side of each of the plurality of LED-end-side first top portion uneven distribution prisms 26A and the opposite-LED-end-side first top portion uneven distribution prisms 26B, advances so as to be directed inward (toward the center side) in the Y-axis direction. In this manner, the light condensing action is imparted such that the emitted light of the first lens sheet 20 advances so as to be directed inward in the Y-axis direction by the first top portion uneven distribution prism 26, and thus, the design conforms to the optical design of the lens unit RE described above.

Incidentally, the incident angle of the light incident on the first lens sheet 20 differs depending on the position in the Y-axis direction. Specifically, most of the incident light on the first lens sheet 20, that is, the emitted light from the light emitting plate surface 15A of the light guide plate 15 advances from the LED end E1 side to the opposite LED end E2 side in the Y-axis direction and is tilted with respect to the Y-axis direction, but the tilt angle with respect to the Y-axis direction differs depending on the position in the Y-axis direction. In the first lens sheet 20, the angle formed by the incident angle of light with respect to the Y-axis direction tends to be smaller on the LED end E1 side in the Y-axis direction than that on the opposite LED end E2 side. Therefore, when the uneven distribution amount of each first top portion in the LED-end-side first top portion uneven distribution prism and the opposite-LED-end-side first top portion uneven distribution prism is the same, there is a concern that the luminance uniformity deteriorates.

Therefore, in the embodiment, in the plurality of first top portion uneven distribution prisms 26, as illustrated in FIG. 6, the first top portions 23A1 are unevenly distributed in the Y-axis direction so as to be asymmetrical in the Y-axis direction. In other words, when those having the same distance from both ends E1 and E2 are picked up one by one from the plurality of LED-end-side first top portion uneven distribution prisms 26A and the opposite-LED-end-side first top portion uneven distribution prism 26B, the uneven distribution amount of the first top portion 23A1 in both 26A and 26B differs. Specifically, as compared with the LED-end-side first top portion uneven distribution prism 26A and the opposite-LED-end-side first top portion uneven distribution prism 26B in which the distance from the LED end E1 and the distance from the opposite LED end E2 are the same, while the LED-end-side first top portion uneven distribution prism 26A has a larger uneven distribution amount of the first top portion 23A1 than that of the opposite-LED-end-side first top portion uneven distribution prism 26B, the opposite-LED-end-side first top portion uneven distribution prism 26B has a smaller uneven distribution amount of the first top portion 23A1 than that of the LED-end-side first top portion uneven distribution prism 26A. According to such a configuration, the main refraction slope 23A2 in the LED-end-side first top portion uneven distribution prism 26A has a larger inclination with respect to the main refraction slope 23A2 (the slope on the opposite light source end side) in the top portion non-uneven distribution prism 27 as compared with the main refraction slope 23A2 in the opposite-LED-end-side first top portion uneven distribution prism 26B. Therefore, even when the angle formed by the incident angle of the light incident on the main refraction slope 23A2 in the LED-end-side first top portion uneven distribution prism 26A with respect to the Y-axis direction is smaller than that the angle of the incident light with respect to the main refraction slope 23A2 in the opposite-LED-end-side first top portion uneven distribution prism 26B, a sufficient refraction action can be imparted. Accordingly, since the refraction action imparted to the incident light on the main refraction slope 23A2 in the LED-end-side first top portion uneven distribution prism 26A and the main refraction slope 23A2 in the opposite-LED-end-side first top portion uneven distribution prism 26B becomes the same, the luminance uniformity in the emitted light of the first lens sheet 20 is higher. As described above, as compared with a case where the uneven distribution amount of each first top portion in the LED-end-side first top portion uneven distribution prism and the opposite-LED-end-side first top portion uneven distribution prism is the same, it is possible to increase the luminance uniformity.

Top angle θ1 and base angles θ2 and θ3 in the first unit prism 23A will be described in detail. First, as illustrated in FIG. 6, the top portion non-uneven distribution prism 27 included in the first unit prism 23A has an isosceles triangular shape, the top angle θ1 is 65°, and the two base angles θ2 and θ3 are both 57.5°. On the other hand, in any of the plurality of first top portion uneven distribution prisms 26 included in the first unit prism 23A, the top angle θ1 is set to 65°, which is the same as that of the top portion non-uneven distribution prism 27, and the two base angles θ2 and θ3 differ depending on the position in the Y-axis direction. In the plurality of LED-end-side first top portion uneven distribution prisms 26A included in the plurality of first top portion uneven distribution prisms 26, the base angle θ2 on the LED end E1 side increases as the position in the Y-axis direction approaches the LED end E1, and the base angle θ3 on the opposite LED end E2 side decreases. Specifically, the maximum value of the base angle θ2 on the LED end E1 side of the LED-end-side first top portion uneven distribution prism 26A is 71°, and the minimum value of the base angle θ3 on the opposite LED end E2 side is 44°. On the other hand, in the plurality of opposite-LED-end-side first top portion uneven distribution prisms 26B included in the plurality of first top portion uneven distribution prisms 26, the base angle θ2 on the LED end E1 side decreases as the position in the Y-axis direction approaches the opposite LED end E2, and the base angle θ3 on the opposite LED end E2 side increases. Specifically, the minimum value of the base angle θ2 on the LED end E1 side of the opposite-LED-end-side first top portion uneven distribution prism 26B is 44.6°, and the maximum value of the base angle θ3 on the opposite LED end E2 side is 70.4°. In other words, the maximum value (71°) of the base angle θ2 on the LED end E1 side of the LED-end-side first top portion uneven distribution prism 26A is larger than the maximum value (70.4°) of the base angle θ3 on the opposite LED end E2 side of the opposite-LED-end-side first top portion uneven distribution prism 26B, and the minimum value (44°) of the base angle θ3 on the opposite LED end E2 side of the LED-end-side first top portion uneven distribution prism 26A is smaller than the minimum value) (44.6° of the base angle θ2 on the LED end E1 side of the opposite-LED-end-side first top portion uneven distribution prism 26B. Here, in a case where the base angle of the top portion non-uneven distribution prism 27 is a reference value (57.5°) and the difference between the reference value and the base angle θ2 on the LED end E1 side of the first unit prism 23A is Δθ, while the maximum value of the difference Δθ in the LED-end-side first top portion uneven distribution prism 26A is 13.5°, the maximum value of the difference Δθ in the opposite-LED-end-side first top portion uneven distribution prism 26B is −12.9°.

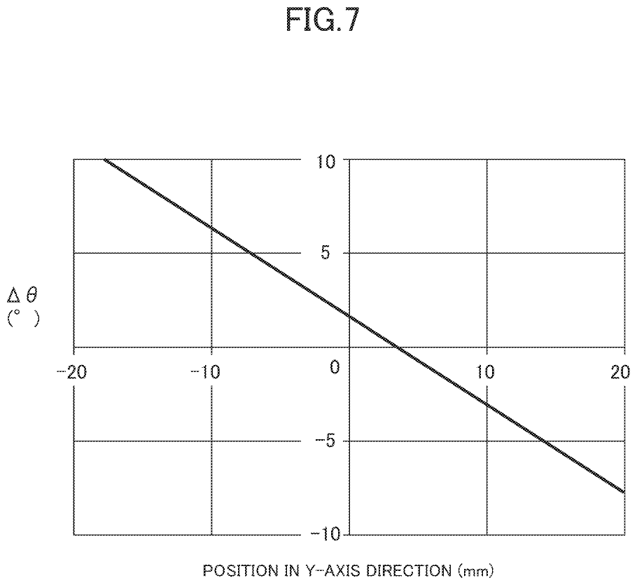

FIG. 7 illustrates a graph illustrating the relationship between the position of the first unit prism 23A in the Y-axis direction and the difference Δθ. In FIG. 7, the horizontal axis indicates the position (unit is “mm”) of the first unit prism 23A in the Y-axis direction, and the vertical axis indicates the difference Δθ (unit is “°”). Regarding the position of the horizontal axis in FIG. 7, positive and negative symbols are attached while the center position of the first lens sheet 20 in the Y-axis direction is a reference position (0 mm), the LED end E1 side from the reference position is a − (negative) side, and the opposite LED end E2 side from the reference position is a + (positive) side. In the difference Δθ on the vertical axis in FIG. 7, in a case where the base angle θ2 on the LED end E1 side of the first unit prism 23A is smaller than the reference value (57.5°), a − (negative) sign is attached, and in a case where the base angle θ2 on the LED end E1 side of the first unit prism 23A is larger than the reference value, a + (positive) sign is attached.

According to the graph illustrated in FIG. 7, it can be seen that the difference Δθ changes linearly depending on the position in the Y-axis direction. The intersection of the graph and the horizontal axis indicates the position of the top portion non-uneven distribution prism 27, and the position is indicated by the + sign. Therefore, it can be seen that the top portion non-uneven distribution prism 27 is positioned on the opposite LED end E2 side of the center position (reference position) in the Y-axis direction of the first lens sheet 20. Along with this, when comparing the LED-end-side first top portion uneven distribution prism 26A and the opposite-LED-end-side first top portion uneven distribution prism 26B with each other having the same distance (the distance from the LED end E1 and the distance from the opposite LED end E2) from the top portion non-uneven distribution prism 27 in the Y-axis direction, the LED-end-side first top portion uneven distribution prism 26A has a larger absolute value of the difference Δθ than that of the opposite-LED-end-side first top portion uneven distribution prism 26B. The difference Δθ at the intersection of the graph and the vertical axis is “+0.3°”.

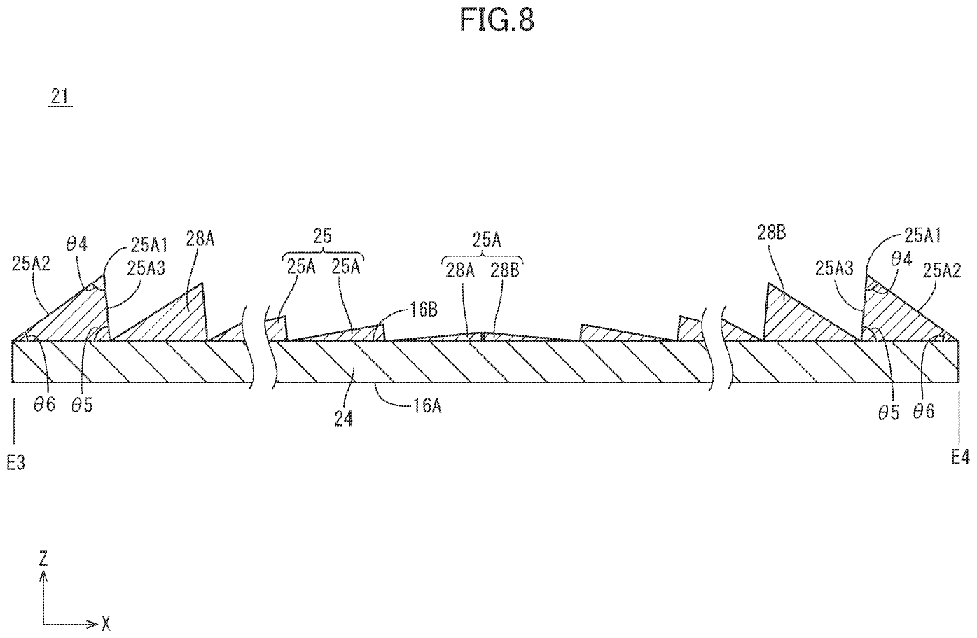

Next, the second prism unit 25 provided in the second lens sheet 21 will be described in detail. As illustrated in FIG. 8, the second prism unit 25 includes a second top portion uneven distribution prism (second top portion uneven distribution prism) 28 in which the second top portions 25A1 are unevenly distributed in the X-axis direction in the plurality of second unit prisms 25A. In the second top portion uneven distribution prism 28, the second top portion 25A1 is displaced to either one side from the center position in the X-axis direction. The second prism unit 25 does not include the top portion non-uneven distribution prism 27 such as the first prism unit 23. According to such a configuration, by adjusting the uneven distribution amount or the like of the second top portion 25A1 in the second top portion uneven distribution prism 28, it is possible to easily control the refraction action imparted to the light by the pair of second slopes 25A2 and 25A3. Here, both ends E3 and E4 in the X-axis direction of the second lens sheet 21 include one end E3 on the left side of FIG. 8 and the other end E4 on the right side of FIG. 8. The second top portion uneven distribution prism 28 includes a plurality of one-end-side second top portion uneven distribution prisms (one-end-side top portion uneven distribution prisms) 28A positioned on one end E3 side of the center position in the X-axis direction, and a plurality of the-other-end-side second top portion uneven distribution prisms (the-other-end-side top portion uneven distribution prisms) 28B positioned on the other end E4 side of the center position in the X-axis direction.

As illustrated in FIG. 8, in any of the second top portion uneven distribution prisms 28 according to the embodiment, the second top portions 25A1 are unevenly distributed on the center side in the X-axis direction. Specifically, the plurality of one-end-side second top portion uneven distribution prisms 28A are arranged in a range from the center of the second lens sheet 21 in the X-axis direction to one end E3, and the second top portions 25A1 are unevenly distributed on the center side in the X-axis direction. On the other hand, the plurality of the-other-end-side second top portion uneven distribution prisms 28B are arranged in a range from the center of the second lens sheet 21 in the X-axis direction to the other end E4, and the second top portions 25A1 are unevenly distributed on the center side in the X-axis direction. In both of the one-end-side second top portion uneven distribution prism 28A and the-other-end-side second top portion uneven distribution prism 28B, of the pair of second slopes 25A2 and 25A3, each second slope 25A2 on one end E3 side and the other end E4 side in the X-axis direction has a smaller inclination angle with respect to the X-axis direction and a larger area than those of each second slope 25A3 on the center side in the X-axis direction. According to such a configuration, to the light incident on each of the plurality of one-end-side second top portion uneven distribution prisms 28A and the-other-end-side second top portion uneven distribution prisms 28B, the refraction action is mainly imparted by each second slope 25A2 on each of one end E3 side and the other end E4 side, and the light advances so as to be directed inward (toward the center side) in the X-axis direction. In this manner, the light condensing action is imparted such that the emitted light of the second lens sheet 21 advances so as to be directed inward in the X-axis direction by the second top portion uneven distribution prism 28, and thus, the design conforms to the optical design of the lens unit RE described above.

Incidentally, there is a case where the luminance distribution of the emitted light of the second lens sheet 21 needs to be flexibly changed according to various conditions. For example, in some cases, there is a concern that the pixel arrangement on the liquid crystal panel 11 and the arrangement of the second unit prisms 25A on the second lens sheet 21 interfere with each other, and interference fringes called moire are visually recognized. In this case, there is a case where a method is employed in which moire is suppressed by rotating the second lens sheet 21 by a predetermined angle from a normal position with respect to the liquid crystal panel 11. In such a case, it needs to change the luminance distribution of the emitted light according to the rotation angle of the second lens sheet 21. In addition to this, for example, there is a case where the heights of the plurality of light emitting plate surface cylindrical lenses 18A in the light guide plate 15 are intentionally varied, and in this case, it needs to change the luminance distribution of the emitted light according to the height distribution of the plurality of light emitting plate surface cylindrical lenses 18A. Therefore, when the uneven distribution amounts of each second top portion of the one-end-side second top portion uneven distribution prism and the-other-end-side second top portion uneven distribution prism are the same, there is a concern that the luminance distribution of the emitted light does not satisfy the demand level.

Therefore, in the embodiment, in the plurality of second top portion uneven distribution prisms 28, as illustrated in FIG. 8, the second top portions 25A1 are unevenly distributed in the X-axis direction so as to be asymmetrical in the X-axis direction. In other words, when those having the same distance from both ends E3 and E4 are picked up one by one from the plurality of one-end-side second top portion uneven distribution prisms 28A and the-other-end-side second top portion uneven distribution prisms 28B, the uneven distribution amount of the second top portions 25A1 in both 28A and 28B differs. Specifically, as compared with the one-end-side second top portion uneven distribution prism 28A and the-other-end-side second top portion uneven distribution prism 28B in which the distance from one end E3 and the distance from the other end E4 is the same, while the one-end-side second top portion uneven distribution prism 28A has a larger uneven distribution amount of the second top portions 25A1 than that of the-other-end-side second top portion uneven distribution prism 28B, the-other-end-side second top portion uneven distribution prism 28B has a smaller uneven distribution amount of the second top portions 25A1 than that of the one-end-side second top portion uneven distribution prism 28A. In addition to the illustration in FIG. 8, it is also possible to reverse the magnitude relationship of the uneven distribution amount of the second top portions 25A1 between the one-end-side second top portion uneven distribution prism 28A and the-other-end-side second top portion uneven distribution prism 28B. According to such a configuration, it is preferable for diversifying the luminance distribution of the emitted light according to various conditions.

Top angle θ4 and base angles θ5 and θ6 in the second unit prism 25A will be described in detail. As illustrated in FIG. 8, in any of the plurality of second top portion uneven distribution prisms 28 included in the second unit prism 25A, while the base angle θ5 on the center side is fixed at 85°, the top angle θ4 and the base angle θ6 on each end E3 and E4 side differs depending on the position in the X-axis direction. In the plurality of one-end-side second top portion uneven distribution prisms 28A included in the plurality of second top portion uneven distribution prisms 28, the base angle θ6 on one end E3 side increases as the position in the X-axis direction approaches one end E3, and the top angle θ4 decreases. Specifically, while the maximum value of the base angle θ6 on one end E3 side of the one-end-side second top portion uneven distribution prism 28A is 36° and the minimum value is 0.8°, and the minimum value of the top angle θ4 is 59° and the maximum value is 94.2°. On the other hand, in the-other-end-side second top portion uneven distribution prisms 28B included in the plurality of second top portion uneven distribution prisms 28, the base angle θ6 on the other end E4 side increases as the position in the X-axis direction approaches the other end E4 side, and the top angle θ4 decreases. Specifically, while the maximum value of the base angle θ6 on the other end E4 side of the-other-end-side second top portion uneven distribution prism 28B is 38° and the minimum value is 0.8°, the minimum value of the top angle θ4 is 57° and the maximum value is 94.2°. In other words, the maximum value (36°) of the base angle θ6 on one end E3 side of the one-end-side second top portion uneven distribution prism 28A is smaller than the maximum value (38°) of the base angle θ6 on the other end E4 side of the-other-end-side second top portion uneven distribution prism 28B, and the minimum value (59°) of the top angle θ4 of the one-end-side second top portion uneven distribution prism 28A is larger than the minimum value (57°) of the top angle θ4 of the-other-end-side second top portion uneven distribution prism 28B.

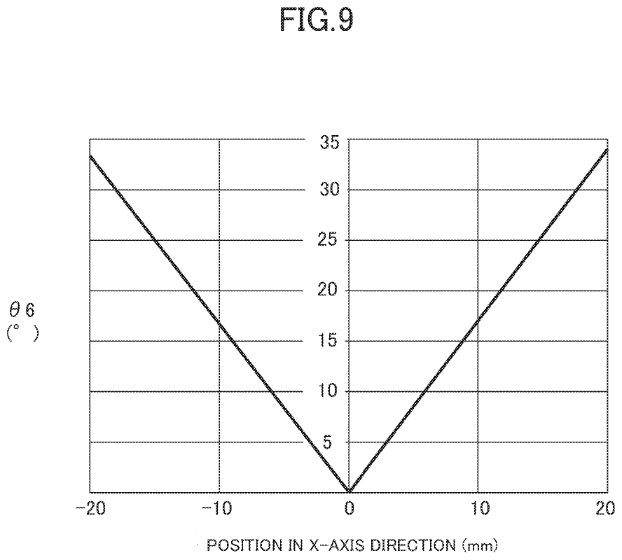

FIG. 9 illustrates a graph illustrating the relationship between the base angle θ6 on each end E3 and E4 side of the second unit prism 25A and the position of the second unit prism 25A in the X-axis direction. In FIG. 9, the horizontal axis indicates the position (unit is “mm”) of the first unit prism 23A in the X-axis direction, and the vertical axis indicates the base angle θ6 (unit is “°”) on each end E3 and E4 side in the second unit prism 25A. Regarding the position of the horizontal axis in FIG. 9, positive and negative symbols are attached while the center position of the second lens sheet 21 in the X-axis direction is a reference position (0 mm), one end E3 side from the reference position is a − (negative) side, and the other end E4 side from the reference position is a + (positive) side.

According to the graph illustrated in FIG. 9, it can be seen that the base angle θ6 changes linearly depending on the position in the X-axis direction. Specifically, as approaching each end E3, E4 side from the reference position in the X-axis direction, any of the base angles θ6 on each end E3 and E4 side in each second unit prism 25A tends to increase. In the one-end-side second top portion uneven distribution prism 28A positioned on one end E3 side in the X-axis direction, as compared with the-other-end-side second top portion uneven distribution prism 28B positioned on the other end E4 side, the change rate of the base angle θ6 with respect to the position change in the X-axis direction decreases.

In the first lens sheet 20 and the second lens sheet 21, as illustrated in FIG. 4, the plate surfaces facing each other are roughened as well as each of the prism units 23 and 25 is not arranged. Specifically, the light emitting surface 16B of the first lens sheet 20 and the light entering surface 16A of the second lens sheet 21 are arranged facing each other so as to be in contact with each other, but both are roughened. According to such a configuration, the plate surfaces facing each other in a state where the first lens sheet 20 and the second lens sheet 21 are overlapped are less likely to be in a close contact state. Accordingly, deterioration of display quality such as moire and rainbow unevenness due to close contact is suppressed. Moreover, the surface roughness of the second lens sheet 21 on the light entering surface 16A is set to be smaller than the surface roughness of the first lens sheet 20 on the light emitting surface 16B. In this manner, as compared with a case where the magnitude relationship of the surface roughness on the plate surfaces facing each other in the first lens sheet and the second lens sheet is reversed, glare is less likely to occur, and deterioration of display quality is more preferably suppressed.

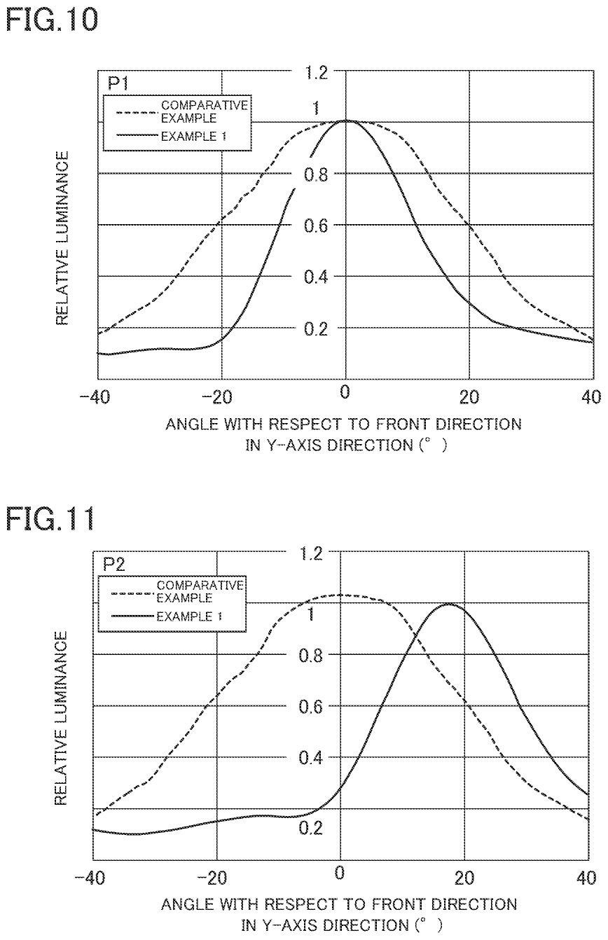

Next, in order to verify the superiority of the liquid crystal display device 10 according to the embodiment, the following Comparative Experiments 1 and 2 were performed. First, in Comparative Experiment 1, while the liquid crystal display device 10 according to the embodiment is used as Example 1 and the liquid crystal display device provided with the backlight device having a configuration different from that of Example 1 is used as Comparative Example, the luminance angle distribution of the emitted light was measured with respect to Example 1 and Comparative Example. The liquid crystal display device 10 according to Example 1 has the configuration as described before this paragraph. The Comparative Example is the same as Example 1 in terms of the LED, but a configuration is employed in which a diffuser sheet for diffusing light as an optical sheet, a prism sheet configured to provide the unit prism extending along the X-axis direction on the plate surface on the light emitting side of the base material, and a prism sheet configured to provide the unit prism extending along the Y-axis direction on the plate surface on the light emitting side of the base material, are arranged to be stacked on the front side of the light guide plate. In Comparative Example 1, the light emitting plate surface is formed to be flat as a light guide plate and a dot pattern for promoting the light emission is formed on the opposite plate surface, and a configuration without the light emitting plate surface lens unit 17 or the emitted-light reflection unit 19 similar to Example 1 is used. In Comparative Experiment 1, the luminance of the emitted light in Example 1 and Comparative Example having the above-described configuration was measured at five measurement points P1 to P5 illustrated in FIG. 3, respectively, and the luminance angle distribution at each measurement point P1 to P5 illustrated in FIGS. 10 to 15 was created, respectively.

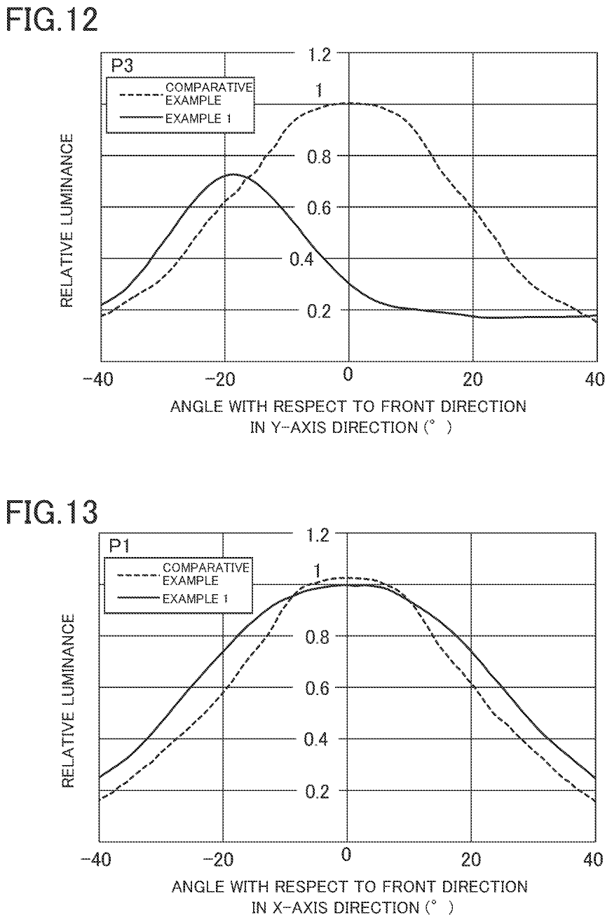

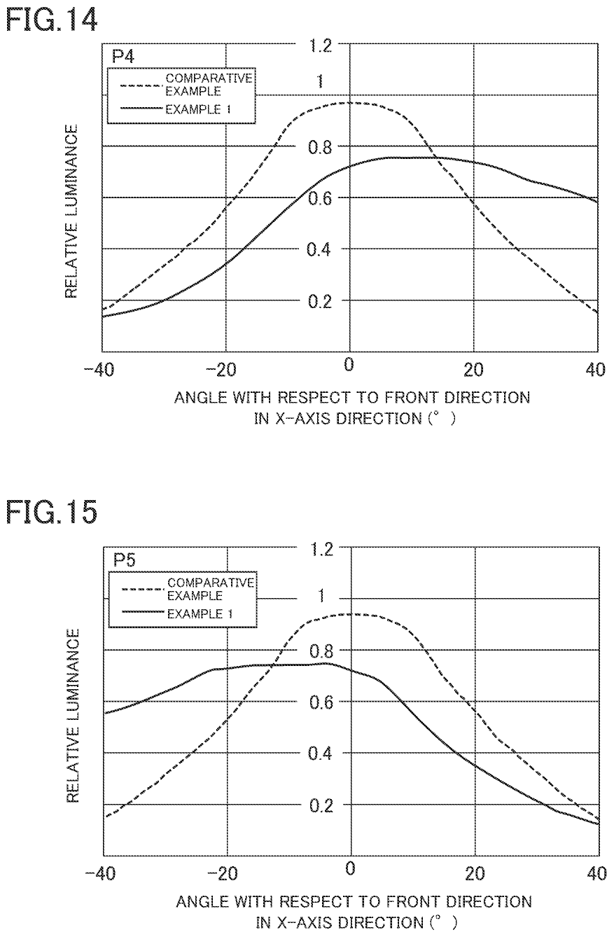

FIG. 10 is a graph illustrating the luminance angle distribution in the Y-axis direction at the measurement point P1 which is the center position in the X-axis direction and the Y-axis direction. FIG. 11 is a graph illustrating the luminance angle distribution in the Y-axis direction at the measurement point P2 which is the center position in the X-axis direction and the LED end E1 in the Y-axis direction. FIG. 12 is a graph illustrating the luminance angle distribution in the Y-axis direction at the measurement point P3 which is the center position in the X-axis direction and the opposite LED end E2 in the Y-axis direction. FIG. 13 is a graph illustrating the luminance angle distribution in the X-axis direction at the measurement point P1 which is the center position in the X-axis direction and the Y-axis direction. FIG. 14 is a graph illustrating the luminance angle distribution in the X-axis direction at the measurement point P4 which is the center position in the Y-axis direction and one end E3 in the X-axis direction. FIG. 15 is a graph illustrating the luminance angle distribution in the X-axis direction at the measurement point P5 which is the center position in the Y-axis direction and the other end E4 in the X-axis direction. In FIGS. 10 to 15, Comparative Example is illustrated by a broken line, and Example 1 is illustrated by a solid line, respectively. In FIGS. 10 to 15, the vertical axis indicates a relative luminance (no unit) while the maximum luminance at the measurement point P1 for Comparative Example is a reference (1.0), and the horizontal axis indicates an angle (unit is “°”) in the X-axis direction or the Y-axis direction with respect to the front direction (Z-axis direction). In the angles of the horizontal axis in FIGS. 10 to 12, a − (negative) side (left sides in FIGS. 10 to 12) with respect to 0° (front direction) which is a reference indicates the LED end E1 side in the Y-axis direction, and a + (positive) side (right sides in FIGS. 10 to 12) with respect to 0° indicates the opposite LED end E2 side in the Y-axis direction, respectively. In the angles of the horizontal axis in FIGS. 13 to 15, a − (negative) side (left sides in FIGS. 13 to 15) with respect to 0° (front direction) which is a reference indicates one end E3 side in the X-axis direction, and a + (positive) side (right sides in FIGS. 13 to 15) with respect to 0° indicates the other end E4 side in the X-axis direction, respectively.

The experimental results of Comparative Experiment 1 will be described. According to FIGS. 11, 12, 14, and 15, in Example 1, the luminance angle distribution of the emitted light at the measurement points P2 to P5 is biased as compared with Comparative Example, and there is a peak of luminance in the vicinity of the angles of ±20° in any cases. Specifically, according to FIG. 11, the luminance of the emitted light at the measurement point P2 is at the peak in the vicinity of +20° in the Y-axis direction. Specifically, according to FIG. 12, the luminance of the emitted light at the measurement point P3 is at the peak in the vicinity of −20° in the Y-axis direction. According to FIG. 14, the luminance of the emitted light at the measurement point P4 is at the peak in the vicinity of +20° in the X-axis direction. According to FIG. 15, the luminance of the emitted light at the measurement point P5 is at the peak in the vicinity of −20° in the X-axis direction. In other words, any emitted light from the measurement points P2 to P5 is light which is directed toward the center side in the X-axis direction and the Y-axis direction, and makes an angle of ±20° on the outside with respect to the Z-axis direction. Therefore, the emitted light of Example 1 is efficiently captured by the lens unit RE illustrated in FIG. 2 and efficiently reaches the eye of the user. When comparing FIGS. 10 to 12 with FIGS. 13 to 15, in Example 1, the light condensing degree of the emitted light is high in the Y-axis direction, and the light condensing degree of the emitted light is low in the X-axis direction. It is presumed that the main reason for this is that the light is more likely to be diffused in the X-axis direction by the light emitting plate surface lenticular lens 18 of the light guide plate 15.

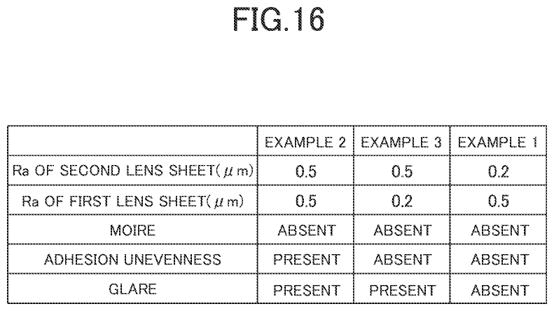

Subsequently, Examples 1 to 3 having different surface roughness of each facing surface of the first lens sheet 20 and the second lens sheet 21 were prepared, and it was inspected whether or not moire, adhesion unevenness, and glare occurred in these Examples 1 to 3. The liquid crystal display device 10 according to Example 1 has the configuration as described before this paragraph. The liquid crystal display device according to Example 2 has the same configuration as described before this paragraph, except that the surface roughness of each facing surface of the first lens sheet 20 and the second lens sheet 21 is the same. Example 3 has the same configuration as described before this paragraph, except that the surface roughness on the light entering surface 16A of the second lens sheet 21 is larger than the surface roughness on the light emitting surface 16B of the first lens sheet 20. Specifically, in Example 1, the arithmetic mean roughness Ra on the light entering surface 16A of the second lens sheet 21 is 0.2 μm, and the arithmetic mean roughness Ra on the light emitting surface 16B of the first lens sheet 20 is 0.5 μm. In Example 2, each arithmetic mean roughness Ra on the light emitting surface 16B of the first lens sheet 20 and the light entering surface 16A of the second lens sheet 21 is set to 0.5 μm. In Example 3, the arithmetic mean roughness Ra on the light entering surface 16A of the second lens sheet 21 is 0.5 μm, and the arithmetic mean roughness Ra on the light emitting surface 16B of the first lens sheet 20 is 0.2 μm. In Examples 1 to 3, when the arithmetic mean roughness Ra of the facing surfaces of each of the lens sheets 20 and 21 is 0.2 μm, the haze value is 9% and when the arithmetic mean roughness Ra is 0.5 μm, the haze value is 3%. The experimental results of Comparative Experiment 2 are as illustrated in FIG. 16. In FIG. 16, with respect to Examples 1 to 3, the arithmetic mean roughness Ra (unit: “μm”) of each facing surface on the first lens sheet 20 and the second lens sheet 21, the presence or absence of moire, the presence or absence of the adhesion unevenness, and the presence or absence of glare are described. In Comparative Experiment 2, each inspection for moire, adhesion unevenness, and glare is a sensory test by an inspector. The adhesion unevenness is an unevenness that is visually recognized as a rainbow-shaped pattern when the facing surfaces of the first lens sheet 20 and the second lens sheet 21 are in close contact with each other.

The experimental results of Comparative Experiment 2 will be described. According to FIG. 16, while adhesion unevenness and glare are present in Example 2 and glare is present in Example 3, any of moire, adhesion unevenness, and glare is absent in Example 1. Based on this, similar to Example 2, when the surface roughness of each facing surfaces of the first lens sheet 20 and the second lens sheet 21 is made the same, it can be seen that the facing surfaces are likely to be in close contact with each other. Similar to Example 3, when the surface roughness of the light entering surface 16A of the second lens sheet 21 is made larger than the surface roughness of the light emitting surface 16B of the first lens sheet 20, it can be seen that the glare are not completely removed. When comparing with these, in Example 1, by making the surface roughness of the light entering surface 16A of the second lens sheet 21 smaller than the surface roughness of the light emitting surface 16B of the first lens sheet 20, the result was achieved in which the glare was removed and it was most difficult to visually recognize various display unevenness.

The liquid crystal display device (display device) 10 according to the embodiment described above includes: the LED (light source) 13; a light guide plate 15 having the light entering end surface 15B which is at least a part of the outer peripheral end surface and on which the light from the LED 13 is incident and the light emitting plate surface 15A which is one of the pair of plate surfaces and emits the light; the liquid crystal panel (display panel) 11 arranged so as to face the light emitting plate surface 15A with respect to the light guide plate 15; and the first lens sheet (lens sheet) 20 that is arranged so as to be interposed between the light guide plate 15 and the liquid crystal panel 11 and refracts the light emitted from the light emitting plate surface 15A. The first lens sheet 20 has the first prism unit (prism unit) 23 arranged on the light entering surface 16A facing the light emitting plate surface 15A, and the first prism unit 23 has the plurality of first unit prisms (unit prisms) 23A arranged along the normal direction of the light entering end surface 15B, extending along the light emitting plate surface 15A and along the orthogonal direction orthogonal to the normal direction, and having the first top portion (top portion) 23A1 and the pair of first slopes (slopes) 23A2 and 23A3 sandwiching the first top portion 23A1, and the plurality of first unit prisms 23A have at least a plurality of first top portion uneven distribution prisms (top portion uneven distribution prisms) 26 in which the first top portions 23A1 are unevenly distributed in the normal direction, and the plurality of first top portion uneven distribution prisms 26 have the LED-end-side first top portion uneven distribution prism (light-source-end-side top portion uneven distribution prism) 26A positioned on the LED end (light source end) E1 side close to the LED 13 in the normal direction and the opposite-LED-end-side first top portion uneven distribution prism (opposite-light-source-end-side top portion uneven distribution prism) 26B which is positioned on the opposite LED end (opposite light source end) E2 side on the opposite side of the LED end E1 in the normal direction, is arranged such that the distance from the opposite LED end E2 is the same as the distance from the LED end E1 to the LED-end-side first top portion uneven distribution prism 26A, and has a different uneven distribution amount of the first top portion 23A1 from that of the LED-end-side first top portion uneven distribution prism 26A.

In this manner, when the light emitted from the LED 13 is incident on the light entering end surface 15B of the light guide plate 15, the light is propagated in the light guide plate 15 and then emitted from the light emitting plate surface 15A to be incident on the light entering surface 16A of the first lens sheet 20. The light incident on the light entering surface 16A of the first lens sheet 20 is refracted by the first slopes 23A2 and 23A3 of the first unit prism 23A that configures the first prism unit 23, and then emitted toward the liquid crystal panel 11, and is used for display. Specifically, since the light that propagates in the light guide plate 15 is emitted from the light emitting plate surface 15A in the process of advancing toward the opposite LED end E2 side from the LED end E1 side in the normal direction of the light entering end surface 15B, to the light incident on the light entering surface 16A of the first lens sheet 20, the refraction action is mainly imparted by the main refraction slope 23A2 on the opposite LED end E2 side in the normal direction of the light entering end surface 15B of the pair of first slopes 23A2 and 23A3 in the first unit prism 23A that configures the first prism unit 23. Furthermore, in the first top portion uneven distribution prism 26 included in the plurality of first unit prisms 23A, the first top portions 23A1 are unevenly distributed in the normal direction of the light entering end surface 15B, and thus, by adjusting the uneven distribution amount or the like, it is possible to easily control the refraction action imparted to the light by the main refraction slope 23A2 on the opposite LED end E2 side.

Incidentally, the incident angle of the light incident on the first lens sheet 20 differs depending on the position of the light entering end surface 15B in the normal direction. Specifically, among the first lens sheets 20, on the LED end E1 side close to the LED 13 in the above-described normal direction and the opposite LED end E2 side far from the LED 13, the incident angle of the light is different from the angle made in the above-described normal direction. Here, the opposite-LED-end-side first top portion uneven distribution prisms 26B included in the plurality of first top portion uneven distribution prisms 26 are arranged such that the distance from the opposite LED end E2 is the same as the distance from the LED end E1 to the LED-end-side first top portion uneven distribution prism 26A and the uneven distribution amount of the LED-end-side first top portion uneven distribution prism 26A is different from that of the first top portion 23A1, and thus, the main refraction slope 23A2 on the opposite LED end E2 side in the LED-end-side first top portion uneven distribution prism 26A has a different inclination from that of the main refraction slope 23A2 on the opposite LED end E2 side of the opposite-LED-end-side first top portion uneven distribution prism 26B. Therefore, even when the angle formed by the incident angle of the light incident on the main refraction slope 23A2 on the opposite LED end E2 side in the LED-end-side first top portion uneven distribution prism 26A with respect to the normal direction is different from the same angle of the incident light with respect to the main refraction slope 23A2 on the opposite LED end E2 side in the opposite-LED-end-side first top portion uneven distribution prism 26B, it is possible to impart a sufficient refraction action. Accordingly, since it is possible to make the refraction action imparted to the incident light equivalent on the main refraction slope 23A2 on the opposite LED end E2 side in the LED-end-side first top portion uneven distribution prism 26A and on the main refraction slope 23A2 on the opposite LED end E2 side in the opposite-LED-end-side first top portion uneven distribution prism 26B, it is possible to make the luminance uniformity in the emitted light of the first lens sheet 20 high. As described above, as compared with a case where the uneven distribution amount of each first top portion 23A1 in the LED-end-side first top portion uneven distribution prism 26A and the opposite-LED-end-side first top portion uneven distribution prism 26B is the same, it is possible to increase the luminance uniformity.

The plurality of first unit prisms 23A have the same top angle at the first top portion 23A1. In this manner, for example, in a case where the first lens sheet 20 is manufactured by resin molding, a mold used for molding can be easily processed.

The plurality of first unit prisms 23A are configured such that the base angles θ2 and θ3 change linearly depending on the position in the normal direction.

The second lens sheet (second lens sheet) 21 arranged so as to be interposed between the first lens sheet 20 and the liquid crystal panel 11 is further provided. The second lens sheet 21 has the second prism unit (second prism unit) 25 arranged on any one of the plate surfaces, the second prism unit 25 has a plurality of second unit prisms (second unit prisms) 25A arranged along the orthogonal direction, extending along the normal direction, and having the second top portion (second top portion) 25A1 and the pair of second slopes (second slopes) 25A2 and 25A3 sandwiching the second top portion 25A1, the plurality of second unit prisms 25A have at least the plurality of second top portion uneven distribution prisms (second top portion uneven distribution prisms) 28 in which the second top portions 25A1 are unevenly distributed in the orthogonal direction, and the plurality of second top portion uneven distribution prisms 28 have the one-end-side second top portion uneven distribution prism (one-end-side top portion uneven distribution prism) 28A positioned on one end E3 side in the orthogonal direction and the-other-end-side second top portion uneven distribution prism (the-other-end-side top portion uneven distribution prism) 28B which is positioned on the other end E4 side in the orthogonal direction, is arranged such that the distance from the other end E4 is the same as the distance from one end E3 to the one-end-side second top portion uneven distribution prism 28A, and has a different uneven distribution amount of the second top portion 25A1 from that of the one-end-side second top portion uneven distribution prism 28A. In this manner, when the light emitted from the first lens sheet 20 is incident on the second lens sheet 21, the light is refracted by the second slopes 25A2 and 25A3 of the second unit prism 25A that configures the second prism unit 25, and then emitted toward the liquid crystal panel 11, and is used for display. In the second top portion uneven distribution prism 28 included in the plurality of second unit prisms 25A, the second top portions 25A1 are unevenly distributed in the orthogonal direction, and thus, by adjusting the uneven distribution amount or the like, it is possible to easily control the refraction action imparted to the light by the second slopes 25A2 and 25A3. Then, the-other-end-side second top portion uneven distribution prisms 28B included in the plurality of second top portion uneven distribution prisms 28 are arranged such that the distance from the other end E4 is the same as the distance from one end E3 to the one-end-side second top portion uneven distribution prism 28A, the uneven distribution amount of the second top portion 25A1 is different from that of the one-end-side second top portion uneven distribution prism 28A, and thus, it is preferable for diversifying the luminance distribution of the emitted light.

The second prism unit 25 is arranged on the plate surface on the opposite side of the side facing the first lens sheet 20, of the plate surface of the second lens sheet 21, and in the first lens sheet 20 and the second lens sheet 21, the plate surfaces facing each other are respectively roughened. In this manner, in a state where the first lens sheet 20 and the second lens sheet 21 are overlapped, the first prism unit 23 and the second prism unit 25 are back-to-back positional relationship. As the plate surfaces facing each other of the first lens sheet 20 and the second lens sheet 21 are respectively roughened, the plate surfaces facing each other are less likely to be in a close contact state. Accordingly, deterioration of display quality such as moire and rainbow unevenness due to close contact is suppressed.

In the second lens sheet 21, the surface roughness of the plate surface facing the first lens sheet 20 is smaller than the surface roughness of the plate surface facing the second lens sheet 21 in the first lens sheet 20. In this manner, as compared with a case where the magnitude relationship of the surface roughness on the plate surfaces facing each other in the first lens sheet 20 and the second lens sheet 21 is reversed, glare is less likely to occur, and deterioration of display quality is improved is more preferably suppressed.

The plurality of second unit prisms 25A are configured such that, while one base angle θ5 of one pair of base angles θ5 and θ6 is all the same, the other base angle θ6 changes linearly depending on the position in the orthogonal direction.

While the plurality of LED-end-side first top portion uneven distribution prisms 26A are arranged in a range from the center of the first lens sheet 20 in the normal direction to the LED end E1, and the first top portions 23A1 are unevenly distributed on the LED end E1 side in the normal direction, the plurality of opposite-LED-end-side first top portion uneven distribution prisms 26B are arranged in a range from the center of the first lens sheet 20 in the normal direction to the opposite LED end E2 and the first top portions 23A1 are unevenly distributed on the opposite LED end E2 side in the normal direction. In this manner, any light refracted by the main refraction slope 23A2 on the opposite LED end E2 side of each of the plurality of LED-end-side first top portion uneven distribution prisms 26A and the opposite-LED-end-side first top portion uneven distribution prisms 26B, advances so as to be directed toward the center side in the normal direction.

The light guide plate 15 has the light emitting plate surface lens unit 17 provided on the light emitting plate surface 15A, and the light emitting plate surface lens unit 17 has the plurality of light emitting plate surface unit lenses 17A extending along the normal direction and arranged along the orthogonal direction. In this manner, when the light that propagates in the light guide plate 15 reaches the light emitting plate surface 15A, the light is reflected by the plurality of light emitting plate surface unit lenses 17A that configure the light emitting plate surface lens unit 17, extend along the normal direction of the light entering end surface 15B, and are arranged along the normal direction, and accordingly, the spread in the orthogonal direction is limited. Accordingly, unevenness of light and darkness is less likely to occur between the vicinity of the LED 13 and the neighbor thereof in the orthogonal direction.

The light emitting plate surface lens unit 17 is the light emitting plate surface lenticular lens 18 in which the plurality of light emitting plate surface unit lenses 17A are configured with the plurality of light emitting plate surface cylindrical lenses 18A. In this manner, the light emitting plate surface cylindrical lens 18A of the light emitting plate surface lenticular lens 18 is more likely to be diffused in the orthogonal direction when the light that propagates in the light guide plate 15 is reflected than the prism. Accordingly, the luminance uniformity becomes higher.

The head-mounted display HMD according to the embodiment includes: the above-described liquid crystal display device 10; the lens unit RE that forms an image displayed on the liquid crystal display device 10 on the eyeball (eye) EY of the user; and the head-mounted device HMDa having the liquid crystal display device 10 and the lens unit RE and mounted on the head HD of the user. According to the head-mounted display HMD of this configuration, when used in a state where the user wears the head-mounted device HMDa on the head HD, the image displayed on the liquid crystal display device 10 is formed on the eyeball EY of the user by the lens unit RE, and thus, the user can visually recognize the image displayed on the liquid crystal display device 10 in an enlarged form. Here, by imparting the refraction action to the emitted light of the first lens sheet 20 by the plurality of first unit prisms 23A that configure the first prism unit 23, the light is angled conforming to the optical characteristics of the lens unit RE. Accordingly, the light can efficiently reach the eyeball EY of the user who visually recognizes the image displayed on the liquid crystal panel 11 in an enlarged form, and the user can visually recognize the bright image.

### Embodiment 2

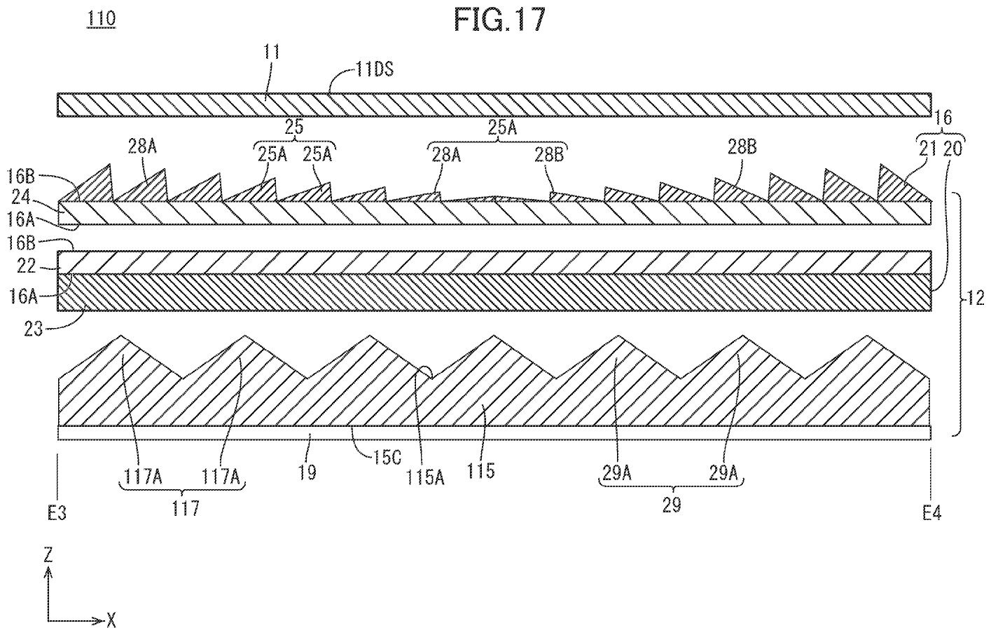

Embodiment 2 will be described with reference to FIGS. 17 to 25. In Embodiment 2, the configuration of a light emitting plate surface lens unit 117 is changed. The duplicate description of the same structure, action, and effect as those in Embodiment 1 described above will be omitted.

As illustrated in FIG. 17, the light emitting plate surface lens unit 117 according to the embodiment is a light emitting plate surface prism 29 in which a plurality of light emitting plate surface unit lenses 117A are configured with a plurality of light emitting plate surface unit prisms 29A. The light emitting plate surface unit prism 29A has a substantially chevron-shaped section cut along the X-axis direction and extends linearly along the Y-axis direction, and the plurality of light emitting plate surface unit prisms 29A are arranged side by side along the X-axis direction on a light emitting plate surface 115A. The light emitting plate surface unit prism 29A has a substantially isosceles triangular shape, and the top angle thereof is, for example, 90°. According to such a configuration, in the light emitting plate surface unit prism 29A of the light emitting plate surface prism 29, as compared with the light emitting plate surface cylindrical lens 18A (refer to FIG. 5) described in Embodiment 1 described above, when the light that propagates in the light guide plate 115 is reflected, the light is unlikely to be diffused in the X-axis direction, and likely to advance along the Y-axis direction. Accordingly, it is preferable for improving the luminance.

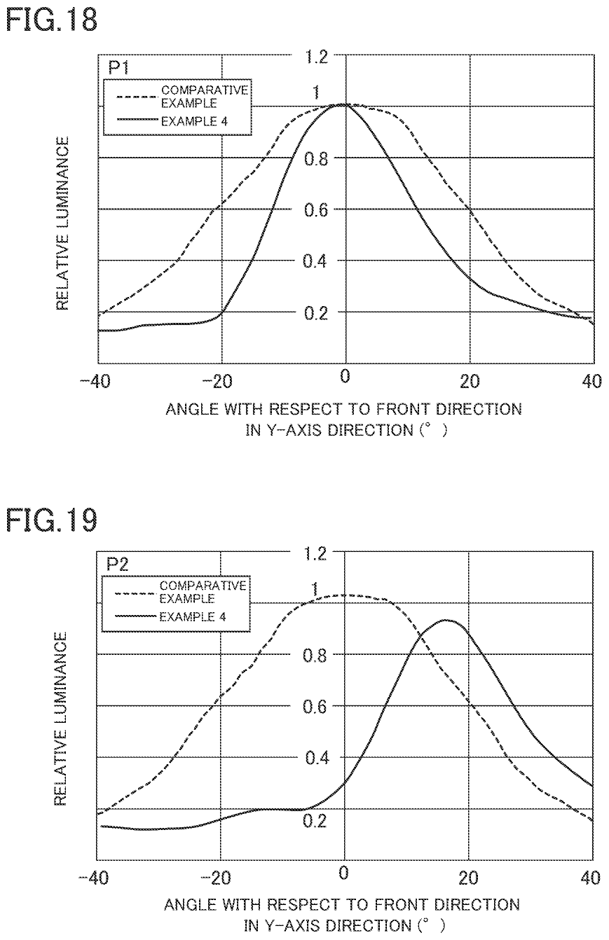

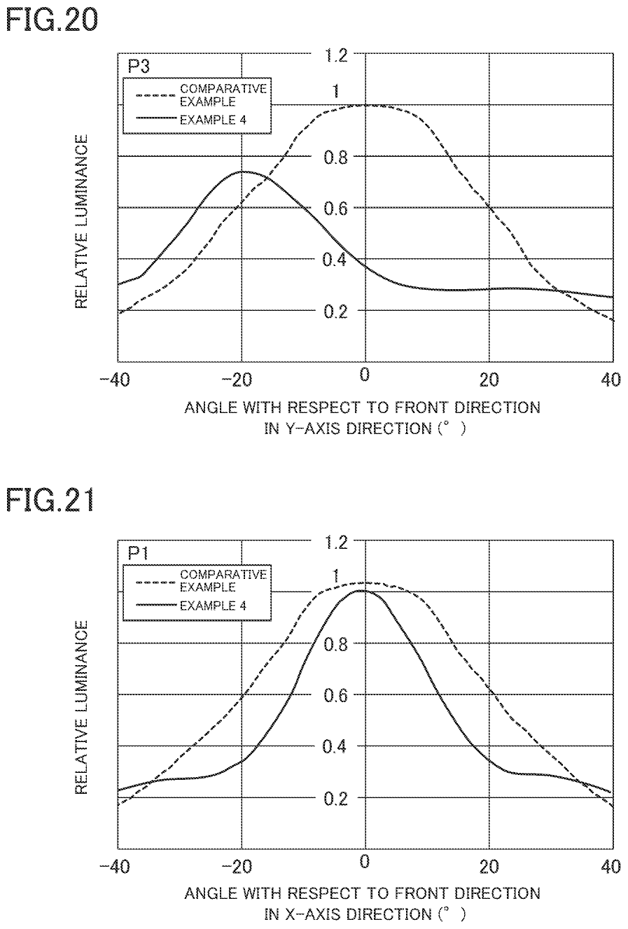

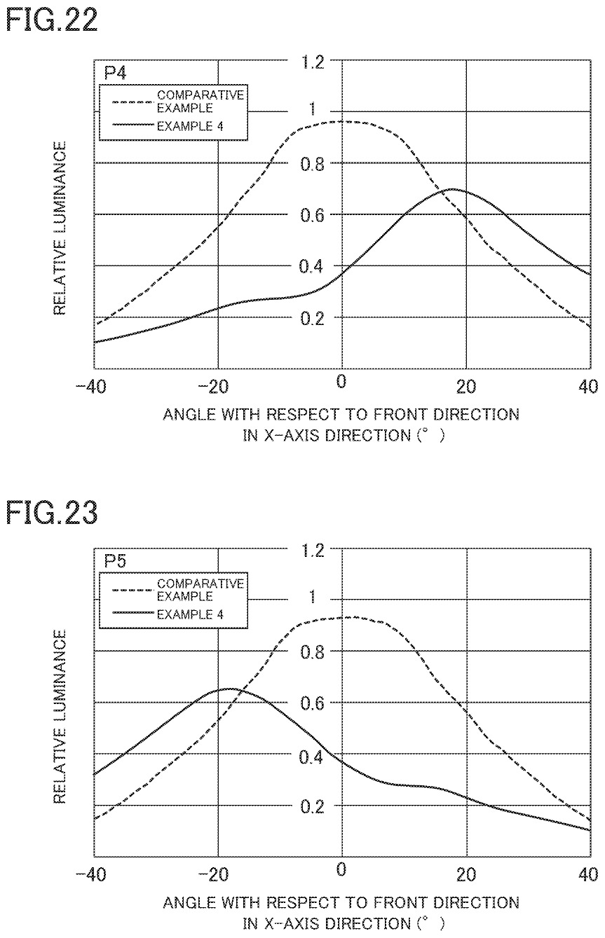

Next, in order to verify the superiority of a liquid crystal display device 110 according to the embodiment, the following Comparative Experiments 3 and 4 were performed. First, in Comparative Experiment 3, the liquid crystal display device 110 according to the embodiment was set as Example 4, and the luminance angle distribution of the emitted light was measured with respect to Example 4 and the same Comparative Example as that in Comparative Experiment 1 described above. The liquid crystal display device 110 according to Example 4 has the configuration as described before this paragraph. In Comparative Experiment 3, the luminance of the emitted light in Example 4 having the above-described configuration and Comparative Example was measured at five measurement points P1 to P5 (refer to FIG. 3) described in Comparative Experiment 1, respectively, and the luminance angle distribution at each measurement point P1 to P5 illustrated in FIGS. 18 to 23 was created, respectively. FIG. 18 is a graph illustrating the luminance angle distribution in the Y-axis direction at the measurement point P1. FIG. 19 is a graph illustrating the luminance angle distribution in the Y-axis direction at the measurement point P2. FIG. 20 is a graph illustrating the luminance angle distribution in the Y-axis direction at the measurement point P3. FIG. 21 is a graph illustrating the luminance angle distribution in the X-axis direction at the measurement point P1. FIG. 22 is a graph illustrating the luminance angle distribution in the X-axis direction at the measurement point P4. FIG. 23 is a graph illustrating the luminance angle distribution in the X-axis direction at the measurement point P5. In FIGS. 18 to 23, Comparative Example is illustrated by a broken line, and Example 4 is illustrated by a solid line, respectively. The vertical axis and horizontal axis in FIGS. 18 to 23 are the same as those in FIGS. 10 to 15 described in Comparative Experiment 1 described above.

The experimental results of Comparative Experiment 3 will be described. According to FIGS. 19, 20, 22, and 23, in Example 4, the luminance angle distribution of the emitted light at the measurement points P2 to P5 is biased as compared with Comparative Example, and similar to Example 1 of Comparative Experiment 1, there is a peak of luminance in the vicinity of the angles of ±20° in any cases. In particular, according to FIGS. 22 and 23, it can be seen that the light condensing degree of the emitted light in the vicinity of the angle of ±20° is higher in Example 4 than that in Example 1 (refer to FIGS. 14 and 15) of Comparative Experiment 1. It is presumed that the main reason for this is that the light emitting plate surface prism 29 of the light guide plate 115 is likely to limit the spread of light in the X-axis direction, and the light diffusion in the X-axis direction is suppressed more than the light emitting plate surface lenticular lens 18 described in Embodiment 1. Accordingly, in the lens unit RE (refer to FIG. 2), the amount of stray light components is reduced and the light is likely to be incident more efficiently, and thus the contrast performance is excellent. According to FIGS. 18 and 21, it can be seen that Embodiment 4 has a higher light condensing degree than that in Comparative Example in terms of the luminance angle distribution in the X-axis direction and the Y-axis direction.

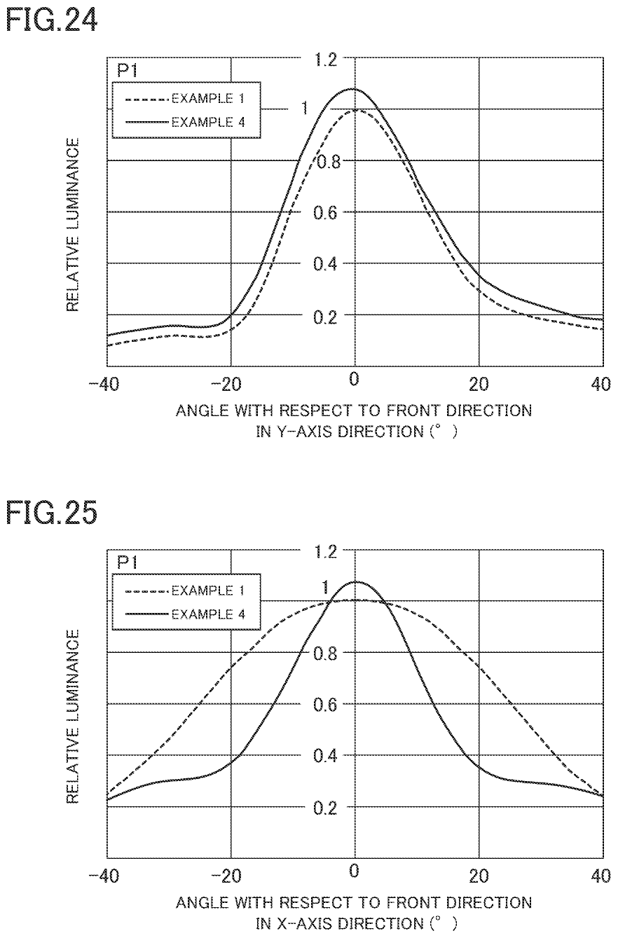

Subsequently, Comparative Experiment 4 will be described. In Comparative Experiment 4, the luminance angle distribution of the emitted light was measured with respect to Example 1 described in Comparative Experiment 1 and Example 4 described in Comparative Experiment 3. In Comparative Experiment 4, the luminance of the emitted light in Example 1 and Example 4 was measured at the measurement point P1 (refer to FIG. 3) described in Comparative Experiment 1, and the luminance angle distribution at each measurement point P1 illustrated in FIGS. 24 and 25 was created, respectively. FIG. 24 is a graph illustrating the luminance angle distribution in the Y-axis direction at the measurement point P1. FIG. 25 is a graph illustrating the luminance angle distribution in the X-axis direction at the measurement point P1. In FIGS. 24 to 25, Example 1 is illustrated by a broken line, and Example 4 is illustrated by a solid line, respectively. The vertical axes of FIGS. 24 and 25 indicate a relative luminance (no unit) while the maximum luminance at the measurement point P1 with respect to Example 1 is the reference point (1.0). The horizontal axes in FIGS. 24 and 25 are the same as those in FIGS. 10 to 13 described in Comparative Experiment 1 described above.

The experimental results of Comparative Experiment 4 will be described. According to FIGS. 24 and 25, in Example 4, the luminance in the front direction is higher than that of Example 1. In particular, according to FIG. 25, it can be seen that the light condensing degree of the emitted light in Example 4 is higher in the X-axis direction than that in Example 1. It is presumed that the main reason for this is that the light emitting plate surface prism 29 of the light guide plate 115 is likely to limit the spread of light in the X-axis direction, and the light diffusion in the X-axis direction is suppressed more than the light emitting plate surface lenticular lens 18 described in Embodiment 1.

As described above, according to the embodiment, the light emitting plate surface lens unit 117 is the light emitting plate surface prism 29 in which the plurality of light emitting plate surface unit lenses 117A are configured with the plurality of light emitting plate surface unit prisms 29A. In this manner, in the light emitting plate surface unit prism 29A of the light emitting plate surface prism 29, as compared with the cylindrical lens, the light is unlikely to be diffused in the orthogonal direction when the light that propagates in the light guide plate 115 is reflected, and likely to advance along the normal direction of the light entering end surface. Accordingly, it is preferable for improving the luminance.

### Embodiment 3

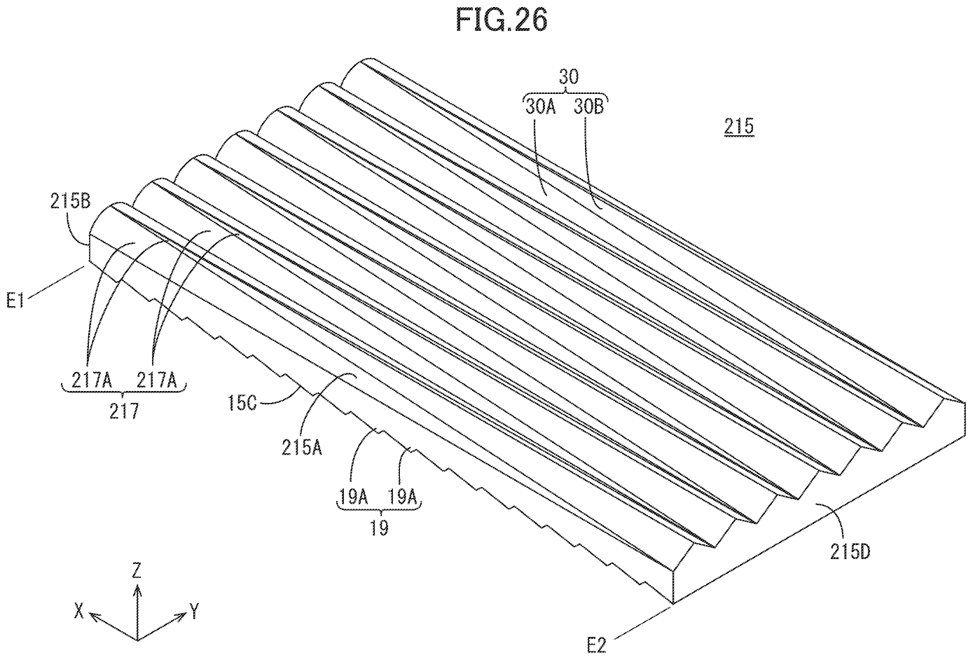

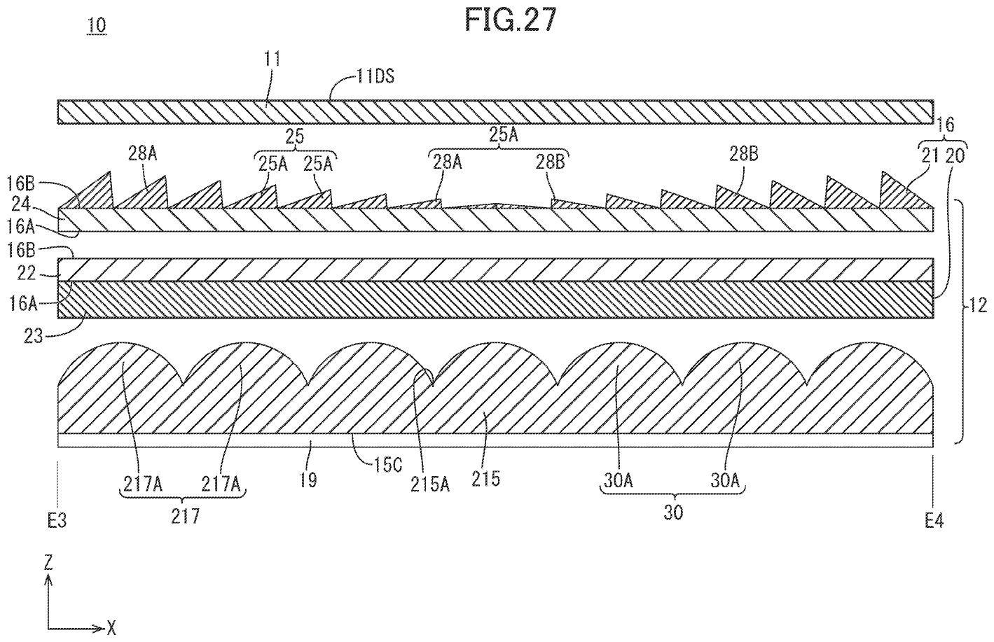

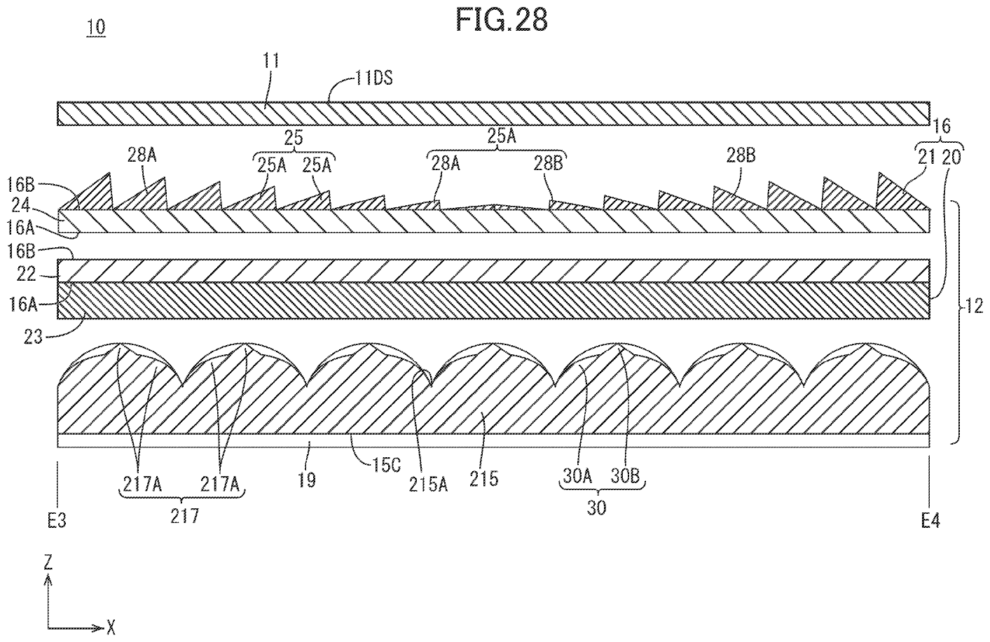

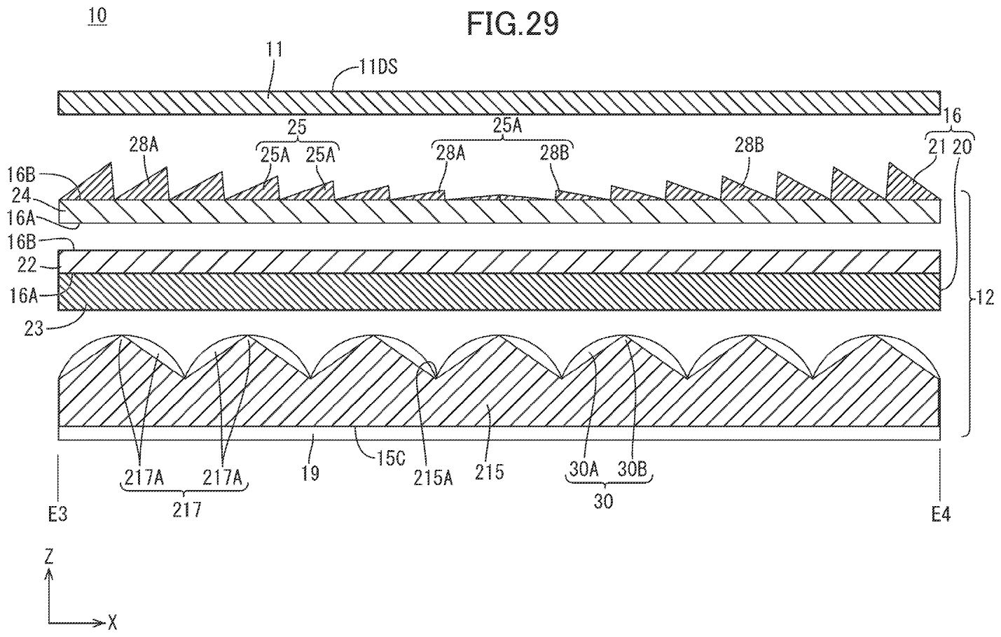

Embodiment 3 will be described with reference to FIGS. 26 to 37. In Embodiment 3, the configuration of a light emitting plate surface lens unit 217 is changed from Embodiment 1 described above. The duplicate description of the same structure, action, and effect as those in Embodiment 1 described above will be omitted.

In the light emitting plate surface lens unit 217 according to the embodiment, as illustrated in FIGS. 26 to 29, a plurality of light emitting plate surface unit lenses 217A are a compound lens 30 configured with a plurality of light emitting plate surface cylindrical lenses 30A and a plurality of light emitting plate surface unit prisms 30B. The light emitting plate surface cylindrical lens 30A and the light emitting plate surface unit prism 30B configuring the compound lens 30 have different occupancy ratio (width dimension) in the X-axis direction in the light emitting plate surface 215A on the side close to the light entering end surface 215B and on the side far from the light entering end surface 215B (the side close to the light entering opposite end surface 215D) in the Y-axis direction. In other words, the light emitting plate surface cylindrical lens 30A is provided such that the occupancy ratio is high on the side close to the light entering end surface 215B in the Y-axis direction, but the occupancy ratio is low on the side far from the light entering end surface 215B in the Y-axis direction. The light emitting plate surface unit prism 30B is provided such that the occupancy ratio is low on the side close to the light entering end surface 215B in the Y-axis direction, but the occupancy ratio is high on the side far from the light entering end surface 215B in the Y-axis direction.

Specifically, in the light emitting plate surface cylindrical lens 30A, as illustrated in FIGS. 26 to 29, the occupancy ratio continuously gradually decreases in the X-axis direction in the light emitting plate surface 215A as moving away from the light entering end surface 215B and approaching the light entering opposite end surface 215D in the Y-axis direction, and conversely, the occupancy ratio continuously gradually increases as moving away from the light entering opposite end surface 215D and approaching the light entering end surface 215B in the Y-axis direction. In the light emitting plate surface unit prism 30B, the occupancy ratio continuously gradually increases in the X-axis direction in the light emitting plate surface 215A as moving away from the light entering end surface 215B and approaching the light entering opposite end surface 215D in the Y-axis direction, and conversely, the occupancy ratio continuously gradually decreases as moving away from the light entering opposite end surface 215D and approaching the light entering end surface 215B in the Y-axis direction. In the light emitting plate surface cylindrical lens 30A, while the occupancy ratio at the LED end E1 of the light guide plate 215 is set to, for example, 100% at the maximum, the occupancy ratio at the opposite LED end E2 is set to, for example, 0% at the minimum. In the light emitting plate surface unit prism 30B, while the occupancy ratio at the LED end E1 of the light guide plate 215 is set to, for example, 0% at the minimum, the occupancy ratio at the opposite LED end E2 is set to, for example, 100% at the maximum.

Here, in the light guide plate 215, on the side close to the light entering end surface 215B in the Y-axis direction of the light entering end surface 215B, as compared with the side far from the light entering end surface 215B, the luminance unevenness is likely to occur in the emitted light from the light emitting plate surface 215A. Meanwhile, on the side far from the light entering end surface 215B in the Y-axis direction, as compared with the side close to the light entering end surface 215B, the luminance of the emitted light from the light emitting plate surface 215A tends to be insufficient. On the other hand, regarding the occupancy ratio of the light emitting plate surface unit prism 30B and the light emitting plate surface cylindrical lens 30A in the X-axis direction on the light emitting plate surface 215A, the occupancy ratio of the light emitting plate surface unit prism 30B is relatively low and the occupancy ratio of the light emitting plate surface cylindrical lens 30A is relatively high on the side close to the light entering end surface 215B in the Y-axis direction, and thus, the luminance unevenness is more preferably suppressed by the light emitting plate surface cylindrical lens 30A on the side close to the light entering end surface 215B in the Y-axis direction where there is a concern about the occurrence of luminance unevenness. Regarding the occupancy ratio of the light emitting plate surface cylindrical lens 30A and the light emitting plate surface unit prism 30B in the X-axis direction on the light emitting plate surface 215A, the occupancy ratio of the light emitting plate surface unit prism 30B is relatively high and the occupancy ratio of the light emitting plate surface cylindrical lens 30A is relatively low on the side far from the light entering end surface 215B in the Y-axis direction, and thus, the luminance is more preferably improved by the light emitting plate surface unit prism 30B on the side far from the light emitting plate surface cylindrical lens 30A in the Y-axis direction where there is a concern about the insufficiency of luminance. As described above, it is possible to more preferably achieve both the improvement of the luminance and the improvement of the luminance uniformity.

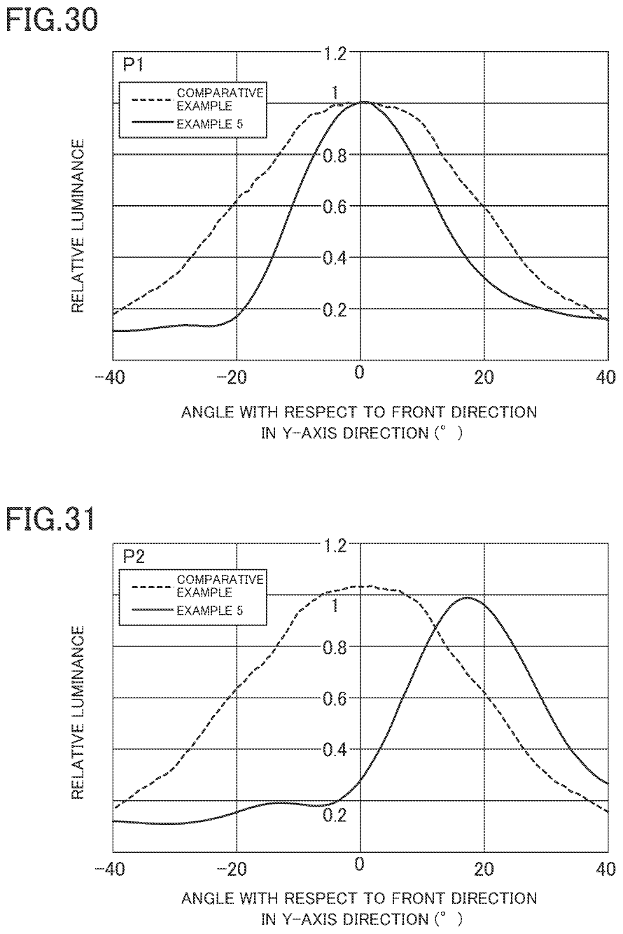

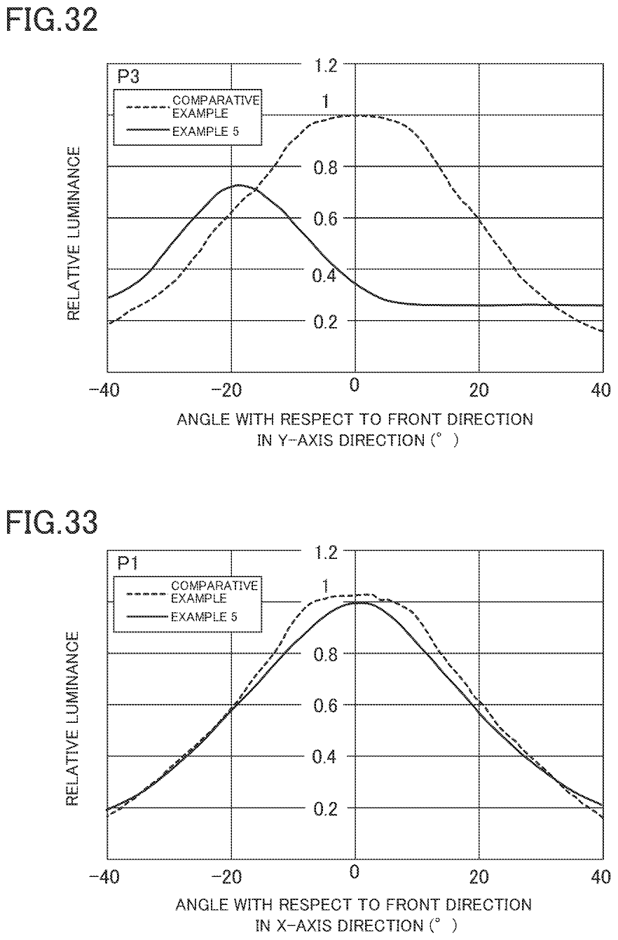

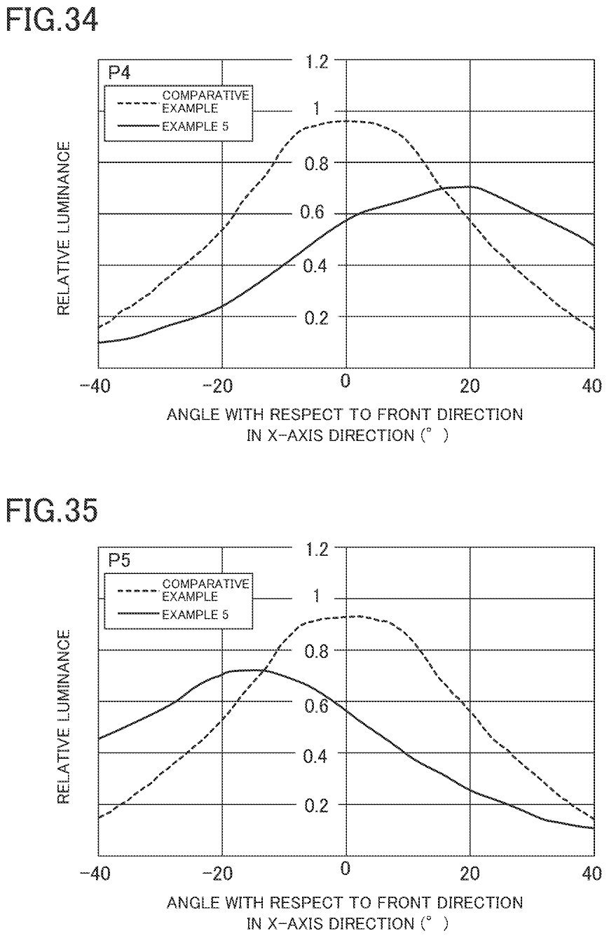

Next, in order to verify the superiority of the liquid crystal display device according to the embodiment, the following Comparative Experiments 5 and 6 were performed. First, in Comparative Experiment 5, the liquid crystal display device according to the embodiment was set as Example 5, and the luminance angle distribution of the emitted light was measured with respect to Example 5 and the same Comparative Example as that in Comparative Experiment 1 described above. The liquid crystal display device according to Example 5 has the configuration as described before this paragraph. In Comparative Experiment 5, the luminance of the emitted light in Example 5 having the above-described configuration and Comparative Example was measured at five measurement points P1 to P5 (refer to FIG. 3) described in Comparative Experiment 1, respectively, and the luminance angle distribution at each measurement point P1 to P5 illustrated in FIGS. 30 to 35 were created, respectively. FIG. 30 is a graph illustrating the luminance angle distribution in the Y-axis direction at the measurement point P1. FIG. 31 is a graph illustrating the luminance angle distribution in the Y-axis direction at the measurement point P2. FIG. 32 is a graph illustrating the luminance angle distribution in the Y-axis direction at the measurement point P3. FIG. 33 is a graph illustrating the luminance angle distribution in the X-axis direction at the measurement point P1. FIG. 34 is a graph illustrating the luminance angle distribution in the X-axis direction at the measurement point P4. FIG. 35 is a graph illustrating the luminance angle distribution in the X-axis direction at the measurement point P5. In FIGS. 30 to 35, Comparative Example is illustrated by a broken line, and Example 5 is illustrated by a solid line, respectively. The vertical axis and horizontal axis in FIGS. 30 to 35 are the same as those in FIGS. 10 to 15 described in Comparative Experiment 1 described above.

The experimental results of Comparative Experiment 5 will be described. According to FIGS. 31, 32, 34, and 35, in Example 5, the luminance angle distribution of the emitted light at the measurement points P2 to P5 is biased as compared with Comparative Example, and similar to Example 1 of Comparative Experiment 1, there is a peak of luminance in the vicinity of the angles of ±20° in any cases. In particular, according to FIGS. 34 and 35, it can be seen that the light condensing degree of the emitted light in the vicinity of the angle of ±20° in Example 5 is slightly higher than that in Example 1 (refer to FIGS. 14 and 15) of Comparative Experiment 1, but the light condensing degree of the emitted light in the vicinity of the angle of ±20° is slightly lower than that of Example 4 (refer to FIGS. 22 and 23) of Comparative Experiment 3. It is presumed that the main reason for this is that the occupancy ratio in the X-axis direction of the light emitting plate surface cylindrical lens 30A and the light emitting plate surface unit prism 30B configuring the compound lens 30 of the light guide plate 215 is variable depending on the positional relationship with the LED, and accordingly, the degree of spread of light in the X-axis direction is appropriately controlled, and the spread of light in the X-axis direction is more appropriately suppressed than that of the light emitting plate surface lenticular lens 18 described in Embodiment 1, but the spread of light in the X-axis direction is promoted more appropriately than that of the light emitting plate surface prism 29 described in Embodiment 2. Accordingly, both the improvement of the luminance and the improvement of the luminance uniformity are achieved. According to FIGS. 30 and 33, it can be seen that Embodiment 5 has a luminance angle distribution in the X-axis direction similar to that in Comparative Example, and a higher light condensing degree than that in Comparative Example in terms of the luminance angle distribution in the Y-axis direction.

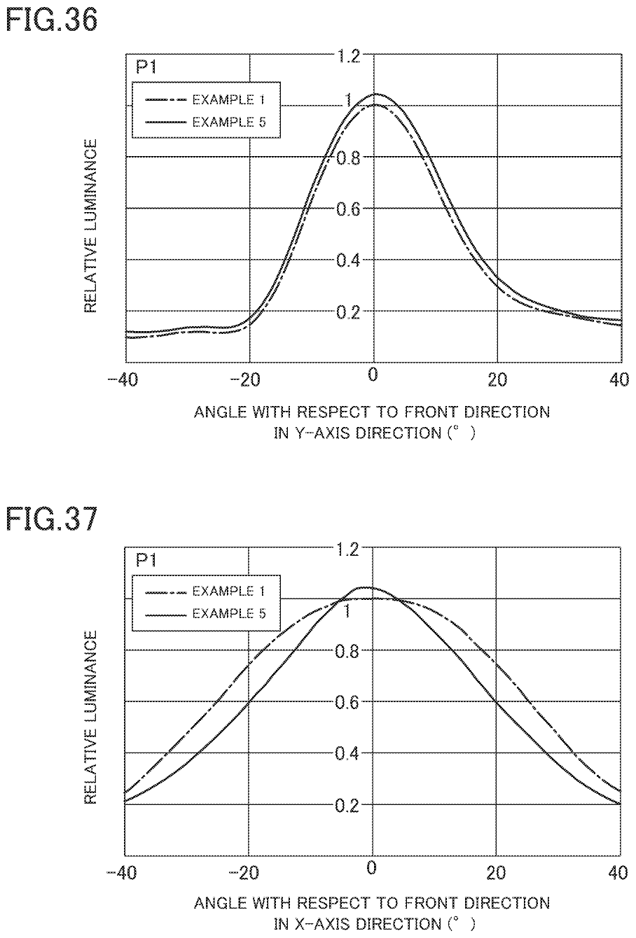

Subsequently, Comparative Experiment 6 will be described. In Comparative Experiment 6, the luminance angle distribution of the emitted light was measured with respect to Example 1 described in Comparative Experiment 1 and Example 5 described in Comparative Experiment 5. In Comparative Experiment 6, the luminance of the emitted light in Example 1 and Example 5 was measured at the measurement point P1 (refer to FIG. 3) described in Comparative Experiment 1, and the luminance angle distribution at each measurement point P1 illustrated in FIGS. 36 and 37 was created, respectively. FIG. 36 is a graph illustrating the luminance angle distribution in the Y-axis direction at the measurement point P1. FIG. 37 is a graph illustrating the luminance angle distribution in the X-axis direction at the measurement point P1. In FIGS. 36 to 37, Example 1 is illustrated by a broken line, and Example 5 is illustrated by a solid line, respectively. The vertical axis and the horizontal axis in FIGS. 36 and 37 are the same as those in FIGS. 24 to 25 described in Comparative Experiment 4 described above.

The experimental results of Comparative Experiment 6 will be described. According to FIGS. 36 and 37, in Example 6, the luminance in the front direction is higher than that of Example 1. In particular, according to FIG. 37, it can be seen that the light condensing degree of the emitted light in Example 5 is slightly higher in the X-axis direction than that in Example 1. Meanwhile, referring to FIG. 25, which is the experimental result of Example 4 of Comparative Experiment 4, it can be seen that Example 5 has a slightly lower light condensing degree of emitted light in the X-axis direction than that in Example 4. It is presumed that the main reason for this is that the occupancy ratio in the X-axis direction of the light emitting plate surface cylindrical lens 30A and the light emitting plate surface unit prism 30B configuring the compound lens 30 of the light guide plate 215 is variable depending on the positional relationship with the LED, and accordingly, the spread of light in the X-axis direction is appropriately controlled.

As described above, according to the embodiment, the light emitting plate surface lens unit 217 is the compound lens 30 in which the plurality of light emitting plate surface unit lenses 217A are configured with the plurality of light emitting plate surface cylindrical lenses 30A and the plurality of light emitting plate surface unit prisms 30B, and in the compound lens 30, regarding the occupancy ratio in the orthogonal direction on the light emitting plate surface 215A, the light emitting plate surface cylindrical lens 30A and the light emitting plate surface unit prism 30B are provided such that, while the occupancy ratio of the light emitting plate surface unit prism 30B is relatively low and the occupancy ratio of the light emitting plate surface cylindrical lens 30A is relatively high on the side close to the light entering end surface 215B in the normal direction, the occupancy ratio of the light emitting plate surface unit prism 30B is relatively high and the occupancy ratio of the light emitting plate surface cylindrical lens 30A is relatively low on the side far from the light entering end surface 215B in the normal direction. In the light guide plate 215, while the luminance unevenness tends to be more likely to occur in the emitted light from the light emitting plate surface 215A on the side close to the light entering end surface 215B in the normal direction of the light entering end surface 215B than that on the side far from the light entering end surface 215B, the luminance of the emitted light from the light emitting plate surface 215A tends to be insufficient on the side far from the light entering end surface 215B in the normal direction more than that on the side close to the light entering end surface 215B. On the other hand, regarding the occupancy ratio of the light emitting plate surface unit prism 30B and the light emitting plate surface cylindrical lens 30A in the orthogonal direction on the light emitting plate surface 215A, the occupancy ratio of the light emitting plate surface unit prism 30B is relatively low and the occupancy ratio of the light emitting plate surface cylindrical lens 30A is relatively high on the side close to the light entering end surface 215B in the normal direction, and thus, the luminance unevenness is more preferably suppressed by the light emitting plate surface cylindrical lens 30A on the side close to the light entering end surface 215B in the normal direction where there is a concern about the occurrence of luminance unevenness. Regarding the occupancy ratio of the light emitting plate surface unit prism 30B and the light emitting plate surface cylindrical lens 30A in the orthogonal direction on the light emitting plate surface 215A, the occupancy ratio of the light emitting plate surface unit prism 30B is relatively high and the occupancy ratio of the light emitting plate surface cylindrical lens 30A is relatively low on the side far from the light entering end surface 215B in the normal direction, and thus, the luminance is more preferably improved by the light emitting plate surface unit prism 30B on the side far from the light emitting plate surface cylindrical lens 30A in the normal direction where there is a concern about the insufficiency of luminance. As described above, it is possible to more preferably achieve both the improvement of the luminance and the improvement of the luminance uniformity.

### Embodiment 4

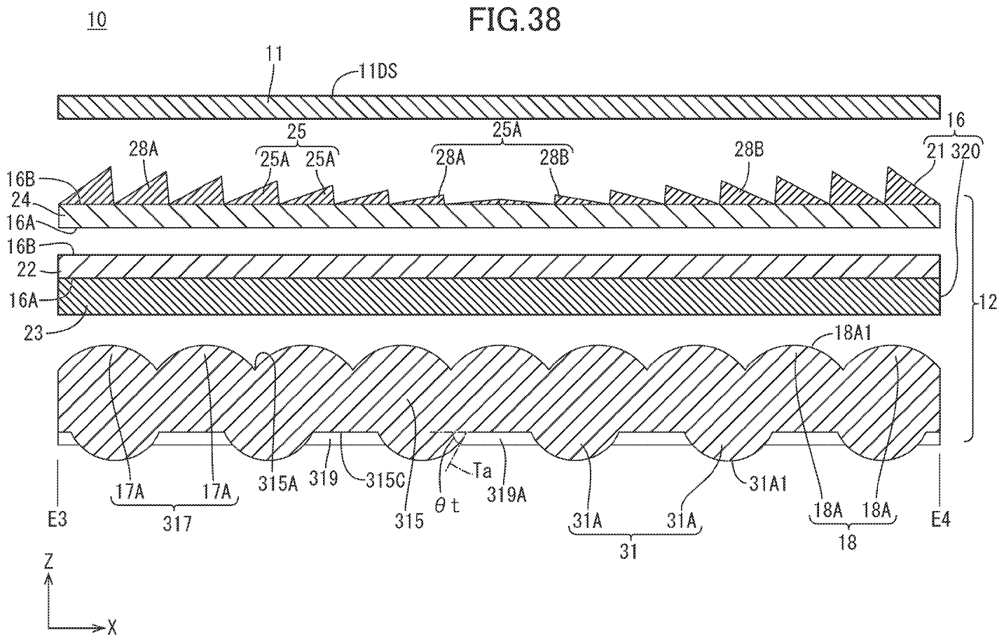

Embodiment 4 will be described with reference to FIGS. 38 to 44. In Embodiment 4, the structure of a light guide plate 315 on a light emitting opposite plate surface 315C is changed from Embodiment 1 described above. The duplicate description of the same structure, action, and effect as those in Embodiment 1 described above will be omitted.

As illustrated in FIG. 38, the light guide plate 315 according to the embodiment has a light emitting opposite plate surface lens unit 31 provided on the light emitting opposite plate surface 315C which is a plate surface on the opposite side of the light emitting plate surface 315A. The light emitting opposite plate surface lens unit 31 has a plurality of light emitting opposite plate surface unit lenses 31A extending along the Y-axis direction and arranged at intervals along the X-axis direction. The light emitting opposite plate surface lens unit 31 is a convex lens in which the light emitting opposite plate surface unit lens 31A protrudes toward the back side from the light emitting opposite plate surface 315C. The light emitting opposite plate surface unit lens 31A is a cylindrical lens having a substantially semi-cylindrical shape of which the axial direction coincides with the Y-axis direction, and the surface oriented toward the back side thereof is a convex arcuate surface 31A1 having an arcuate shape. The light emitting opposite plate surface unit lens 31A has a substantially semicircular section cut along the X-axis direction orthogonal to the axial direction thereof. In the light emitting opposite plate surface unit lens 31A, when the angle θt formed by the tangent line Ta at the base end portion of the arcuate surface 31A1 with respect to the X-axis direction is defined as “tangent angle”, the tangent angle θt is, for example, approximately 45°, but the disclosure is not necessarily limited thereto. A plurality of the light emitting opposite plate surface unit lenses 31A are arranged side by side on the light emitting opposite plate surface 315C at substantially certain intervals along the X-axis direction. The plurality of light emitting opposite plate surface unit lenses 31A arranged along the X-axis direction have the tangent angle θt, the width dimension and the height dimension of the bottom surface which are all substantially the same, and are arranged at substantially certain intervals with the arrangement interval between the adjacent light emitting opposite plate surface unit lenses 31A. According to such a configuration, when the light that propagates in the light guide plate 315 reaches the light emitting opposite plate surface 315C, the light is reflected by the plurality of light emitting opposite plate surface unit lenses 31A that configure the light emitting opposite plate surface lens unit 31, extend along the Y-axis direction of the light entering end surface 315B, and are arranged along the X-axis direction, and accordingly, the spread in the X-axis direction is limited. In other words, the spread in the X-axis direction of the light that propagates in the light guide plate 315 is limited by the light emitting plate surface lens unit 317 on the light emitting plate surface 315A and by the light emitting opposite plate surface lens unit 31 on the light emitting opposite plate surface 315C, respectively, and accordingly, the light can be easily distributed evenly in the Y-axis direction, and thus, unevenness of light and darkness between the vicinity of the LED and the neighbor thereof in the X-axis direction is less likely to occur.

As illustrated in FIG. 38, in the light emitting opposite plate surface unit lens 31A, the extending direction coincides with the Y-axis direction, and is orthogonal to the X-axis direction which is the extending direction of the unit reflection unit 319A that configures an emitted-light reflection unit 319 provided on the same light emitting opposite plate surface 315C. The light emitting opposite plate surface lens unit 31 is formed such that the light emitting opposite plate surface unit lens 31A protrudes toward the back side (outside) from the unit reflection unit 319A. Therefore, the unit reflection unit 319A is selectively provided at a part of the light emitting opposite plate surface 315C where the light emitting opposite plate surface unit lens 31A is not arranged in the X-axis direction. In this manner, the light emitting opposite plate surface lens unit 31 is formed such that the light emitting opposite plate surface unit lens 31A protrudes outward from the unit reflection unit 319A, and thus, in a case where sheets, such as a reflective sheet, are arranged on the back side (the opposite side of the first lens sheet 320 side) with respect to the light guide plate 315, the situation where the emitted-light reflection unit 319 is in close contact with the sheets is less likely to occur.

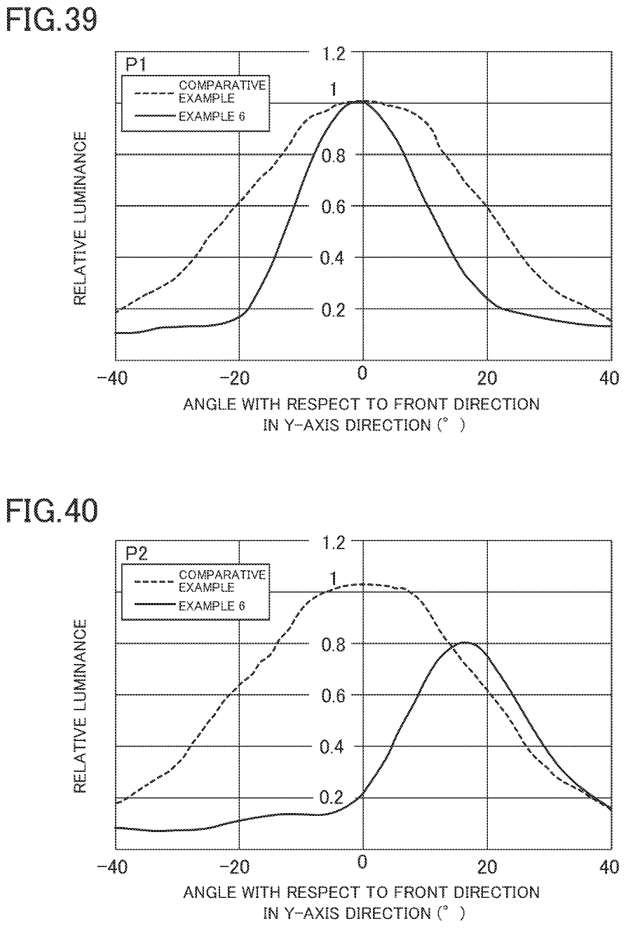

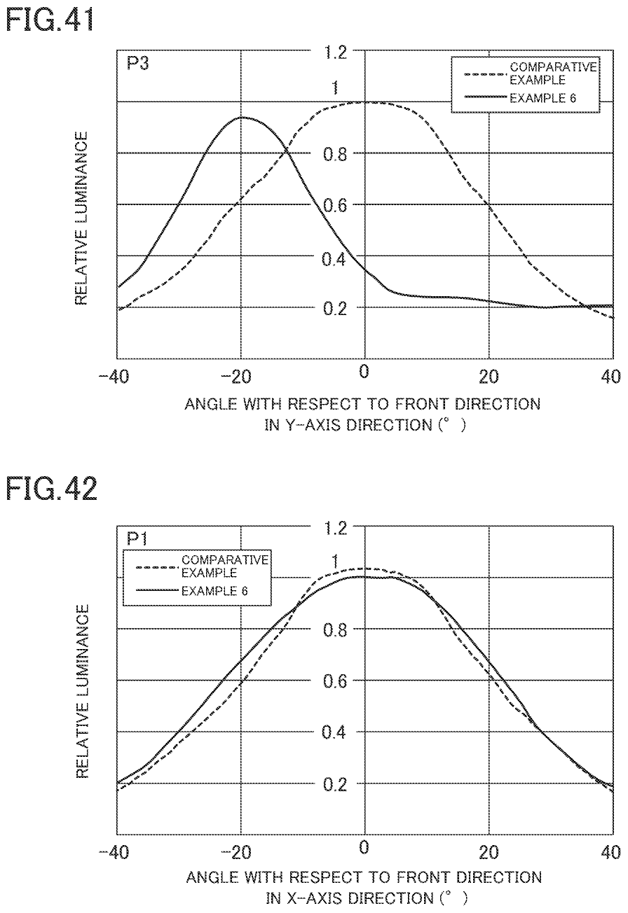

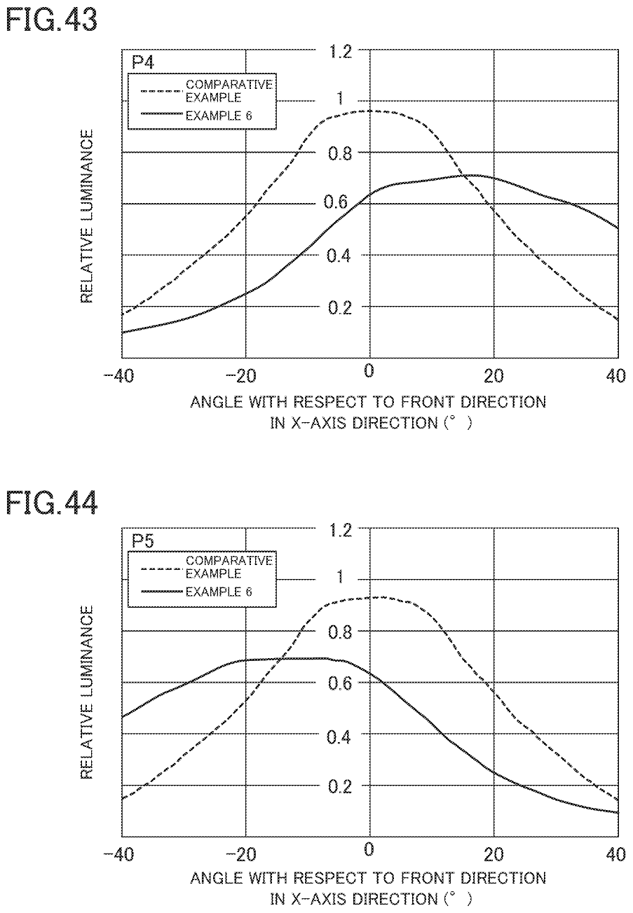

Next, in order to verify the superiority of the liquid crystal display device according to the embodiment, the following Comparative Experiment 7 was performed. In Comparative Experiment 7, the liquid crystal display device according to the embodiment was set as Example 6, and the luminance angle distribution of the emitted light was measured with respect to Example 6 and the same Comparative Example as in Comparative Experiment 1 described above. The liquid crystal display device according to Example 6 has the configuration as described before this paragraph. In Comparative Experiment 7, the luminance of the emitted light in Example 6 having the above-described configuration and Comparative Example was measured at five measurement points P1 to P5 (refer to FIG. 3) described in Comparative Experiment 1, respectively, and the luminance angle distribution at each measurement point P1 to P5 illustrated in FIGS. 39 to 44 was created, respectively. FIG. 39 is a graph illustrating the luminance angle distribution in the Y-axis direction at the measurement point P1. FIG. 40 is a graph illustrating the luminance angle distribution in the Y-axis direction at the measurement point P2. FIG. 41 is a graph illustrating the luminance angle distribution in the Y-axis direction at the measurement point P3. FIG. 42 is a graph illustrating the luminance angle distribution in the X-axis direction at the measurement point P1. FIG. 43 is a graph illustrating the luminance angle distribution in the X-axis direction at the measurement point P4. FIG. 44 is a graph illustrating the luminance angle distribution in the X-axis direction at the measurement point P5. In FIGS. 39 to 44, Comparative Example is illustrated by a broken line, and Example 6 is illustrated by a solid line, respectively. The vertical axis and horizontal axis in FIGS. 39 to 44 are the same as those in FIGS. 10 to 15 described in Comparative Experiment 1 described above.

The experimental results of Comparative Experiment 7 will be described. According to FIGS. 40, 41, 43, and 44, in Example 6, the luminance angle distribution of the emitted light at the measurement point P2 to P5 is biased as compared with Comparative Example, and similar to Example 1 of Comparative Experiment 1, there is a peak of luminance in the vicinity of the angles of ±20° in any cases. In particular, according to FIGS. 40 and 41, in Example 6, it can be seen that the luminance of the emitted light at the measurement point P2 and the measurement point P3 is the same and the luminance uniformity in the Y-axis direction is improved as compared with Example 1 (refer to FIGS. 11 and 12) of Comparative Experiment 1. It is presumed that the main reason for this is that the spread in the X-axis direction of the light that propagates in the light guide plate 315 is limited by the light emitting plate surface lens unit 317 on the light emitting plate surface 315A and by the light emitting opposite plate surface lens unit 31 on the light emitting opposite plate surface 315C, respectively, and accordingly, the light can be easily distributed evenly in the Y-axis direction. According to FIGS. 39 and 42, it can be seen that Embodiment 6 has a luminance angle distribution in the X-axis direction similar to that in Comparative Example, and a higher light condensing degree than that in Comparative Example in terms of the luminance angle distribution in the Y-axis direction.

As described above, according to the embodiment, the light guide plate 315 has the light emitting opposite plate surface lens unit 31 provided on the light emitting opposite plate surface 315C which is the plate surface on the opposite side of the light emitting plate surface 315A, and the light emitting opposite plate surface lens unit 31 has the plurality of light emitting opposite plate surface unit lenses 31A extending along the normal direction and arranged at intervals along the orthogonal direction. In this manner, when the light that propagates in the light guide plate 315 reaches the light emitting opposite plate surface 315C, the light is reflected by the plurality of light emitting opposite plate surface unit lenses 31A that configure the light emitting opposite plate surface lens unit 31, extend along the normal direction of the light entering end surface 315B, and are arranged along the normal direction, and accordingly, the spread in the orthogonal direction is limited. In other words, since the spread in the orthogonal direction of the light that propagates in the light guide plate 315 is limited by the light emitting plate surface lens unit 317 and the light emitting opposite plate surface lens unit 31, respectively, and thus, unevenness of light and darkness between the vicinity of the LED and the neighbor thereof in the orthogonal direction is less likely to occur.

The light guide plate 315 has the emitted-light reflection unit 319 provided on the light emitting opposite plate surface 315C, the emitted-light reflection unit 319 has the plurality of unit reflection units 319A extending along the orthogonal direction and arranged at intervals along the normal direction, and the light emitting opposite plate surface lens unit 31 is formed such that the light emitting opposite plate surface unit lens 31A protrudes outward from the unit reflection unit 319A. In this manner, the light that propagates in the light guide plate 15 is reflected by the unit reflection unit 319A extending along the normal direction on the way, and accordingly, the emission from the light emitting plate surface 315A is promoted. Moreover, the light emitting opposite plate surface lens unit 31 is formed such that the light emitting opposite plate surface unit lens 31A protrudes outward from the unit reflection unit 319A, and thus, in a case where sheets are arranged on the opposite side of the first lens sheet 320 side with respect to the light guide plate 315, the situation where the emitted-light reflection unit 319 is in close contact with the sheets is less likely to occur.

### Embodiment 5

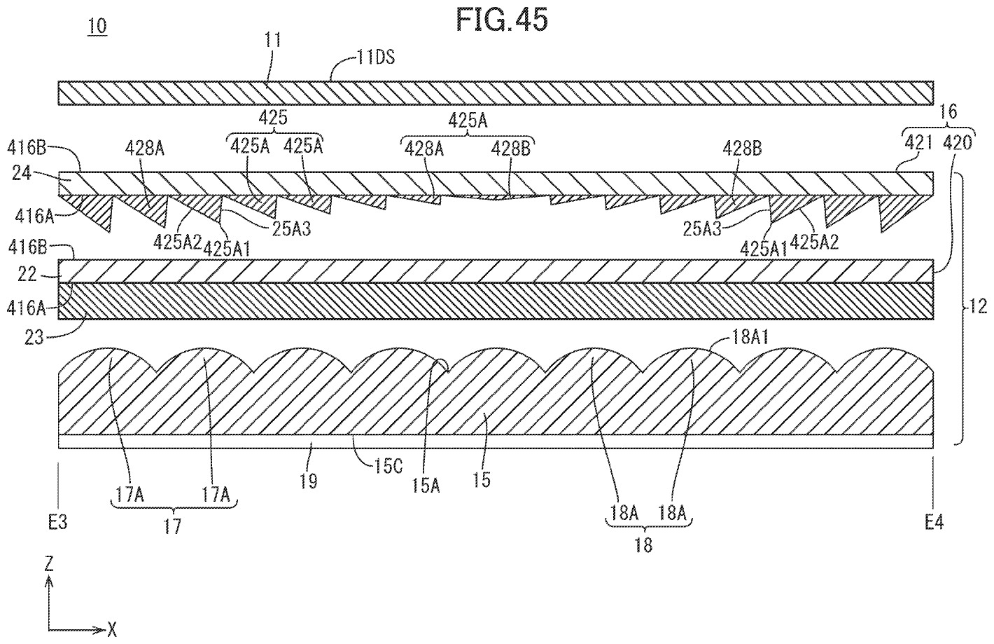

Embodiment 5 will be described with reference to FIGS. 45 to 51. In Embodiment 5, the configuration of a second lens sheet 421 is changed from Embodiment 1 described above. The duplicate description of the same structure, action, and effect as those in Embodiment 1 described above will be omitted.

In the second lens sheet 421 according to the embodiment, as illustrated in FIG. 45, the second prism unit 425 is configured to be arranged on a light entering surface 416A that faces a first lens sheet 420 on the plate surface of the second lens sheet 421. The second prism unit 425 has a configuration in which a plurality of second unit prisms 425A are provided so as to protrude from the light entering surface 416A of the second lens sheet 421 toward the back side. According to such a configuration, in a state where the first lens sheet 420 and the second lens sheet 421 are overlapped, the second prism unit 425 abuts against a light emitting surface 416B that faces the second lens sheet 421 in the first lens sheet 420. Accordingly, close contact of the plate surfaces that face each other in the first lens sheet 420 and the second lens sheet 421 is suppressed, and thus, deterioration of display quality such as moire and rainbow unevenness due to the close contact is suppressed. Moreover, when the light emitted from the first lens sheet 420 is incident on the second lens sheet 421, the refraction action is directly imparted by the second prism unit 425, and thus, the optical performance of the second prism unit 425 is excellently exhibited. Accordingly, the luminance uniformity becomes higher.

In any of the second top portion uneven distribution prisms 428 included in the plurality of second unit prisms 425A, as illustrated in FIG. 45, the second top portions 425A1 are unevenly distributed on the center side in the X-axis direction. According to such a configuration, to the light incident on each of a plurality of one-end-side second top portion uneven distribution prisms 428A and the-other-end-side second top portion uneven distribution prisms 428B, the refraction action is mainly imparted by each second slope 425A2 on each of one end E3 side and the other end E4 side, and the light advances so as to be directed inward (toward the center side) in the X-axis direction. As described above, the light condensing action is imparted such that the emitted light of the second lens sheet 421 advances so as to be directed inward in the X-axis direction by the second top portion uneven distribution prism 428, and thus, the design conforms to the optical design of the lens unit RE (refer to FIG. 2).

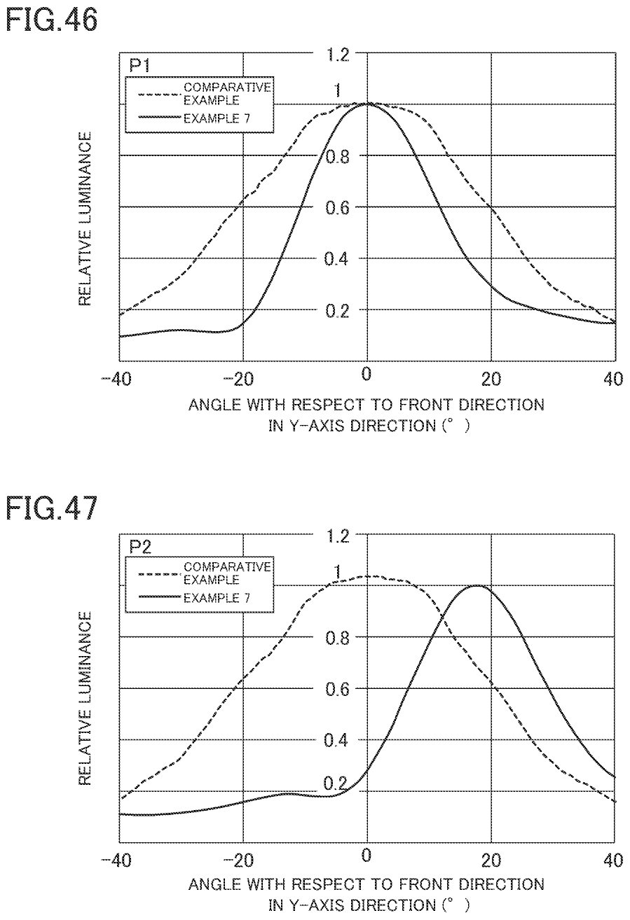

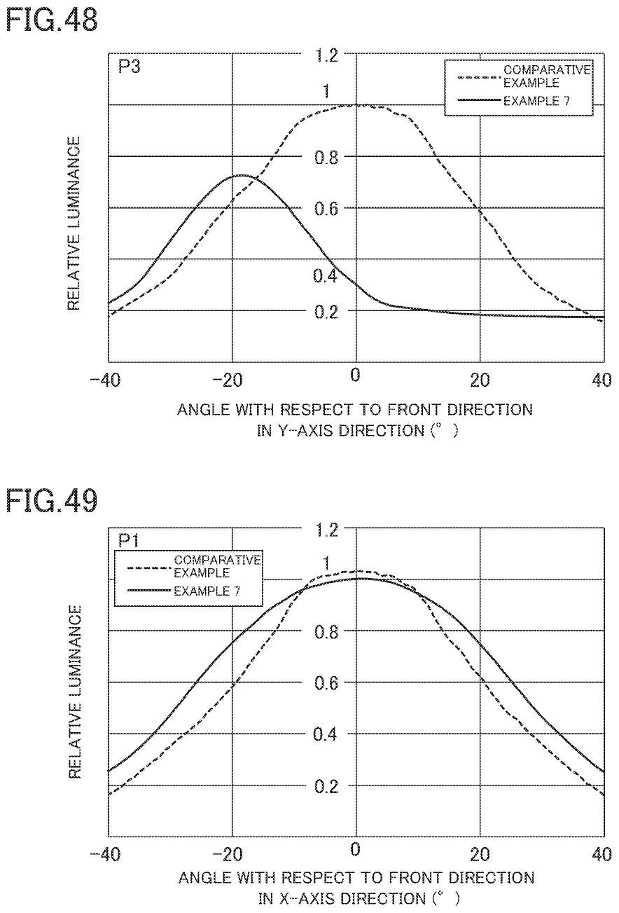

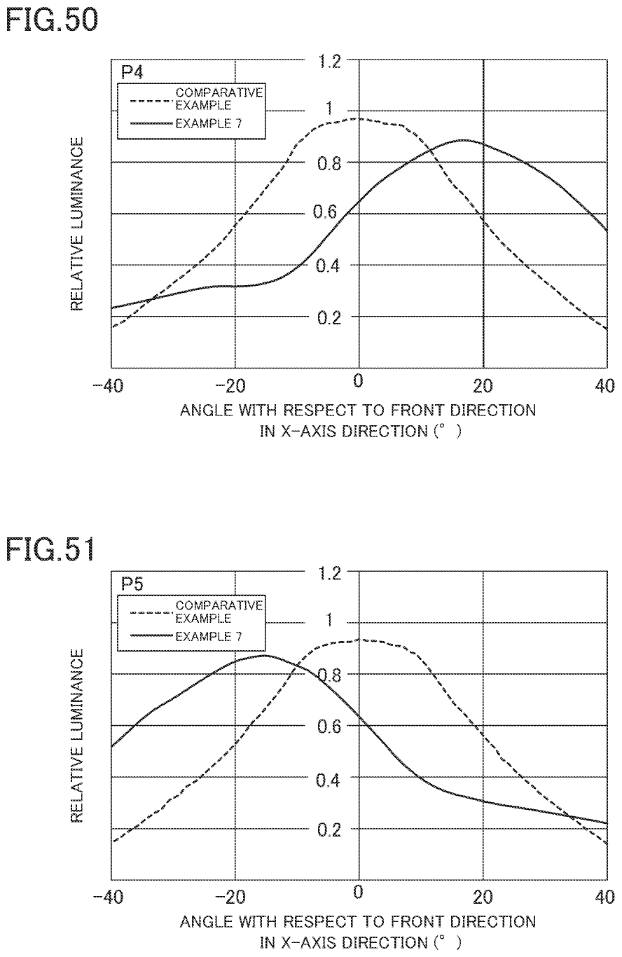

Next, in order to verify the superiority of the liquid crystal display device according to the embodiment, the following Comparative Experiment 8 was performed. In Comparative Experiment 8, the liquid crystal display device according to the embodiment was set as Example 7, and the luminance angle distribution of the emitted light was measured with respect to Example 7 and the same Comparative Example as that in Comparative Experiment 1 described above. The liquid crystal display device according to Example 7 has the configuration as described before this paragraph. In Comparative Experiment 8, the luminance of the emitted light in Example 7 and Comparative Example having the above-described configuration was measured at five measurement points P1 to P5 (refer to FIG. 3) described in Comparative Experiment 1, respectively, and the luminance angle distribution at each measurement point P1 to P5 illustrated in FIGS. 46 to 51 was created, respectively. FIG. 46 is a graph illustrating the luminance angle distribution in the Y-axis direction at the measurement point P1. FIG. 47 is a graph illustrating the luminance angle distribution in the Y-axis direction at the measurement point P2. FIG. 48 is a graph illustrating the luminance angle distribution in the Y-axis direction at the measurement point P3. FIG. 49 is a graph illustrating the luminance angle distribution in the X-axis direction at the measurement point P1. FIG. 50 is a graph illustrating the luminance angle distribution in the X-axis direction at the measurement point P4. FIG. 51 is a graph illustrating the luminance angle distribution in the X-axis direction at the measurement point P5. In FIGS. 46 to 51, Comparative Example is illustrated by a broken line, and Example 7 is illustrated by a solid line, respectively. The vertical axis and horizontal axis in FIGS. 46 to 51 are the same as those in FIGS. 10 to 15 described in Comparative Experiment 1 described above.

The experimental results of Comparative Experiment 8 will be described. According to FIGS. 47, 48, 50, and 51, in Example 7, the luminance angle distribution of the emitted light at the measurement points P2 to P5 is biased as compared with Comparative Example, and similar to Example 1 of Comparative Experiment 1, there is a peak of luminance in the vicinity of the angles of ±20° in any cases. In particular, according to FIGS. 50 and 51, it can be seen that the luminance of the emitted light both at the measurement point P4 and the measurement point P5 is higher in Example 7 than that in Example 1 (refer to FIGS. 14 and 15) of Comparative Experiment 1. It is presumed that the main reason for this is that the second prism unit 425 is arranged on the light entering surface 416A of the second lens sheet 421 and accordingly, the optical performance of the second prism unit 425 is excellently exhibited. According to FIGS. 46 and 49, it can be seen that Embodiment 7 has a luminance angle distribution in the X-axis direction similar to that in Comparative Example, and a higher light condensing degree than that in Comparative Example in terms of the luminance angle distribution in the Y-axis direction.

As described above, according to the embodiment, the second prism unit 425 is arranged on the plate surface that faces the first lens sheet 420 on the plate surface of the second lens sheet 421. In this manner, in a state where the first lens sheet 420 and the second lens sheet 421 are overlapped, the second prism unit 425 abuts against the plate surface that faces the second lens sheet 421 in the first lens sheet 420. Accordingly, close contact of the plate surfaces that face each other in the first lens sheet 420 and the second lens sheet 421 is suppressed, and thus, deterioration of display quality such as moire and rainbow unevenness due to the close contact is suppressed. Moreover, when the light emitted from the first lens sheet 420 is incident on the second lens sheet 421, the refraction action is directly imparted by the second prism unit 425, and thus, the optical performance of the second prism unit 425 is excellently exhibited. Accordingly, the luminance uniformity becomes higher.

### Embodiment 6

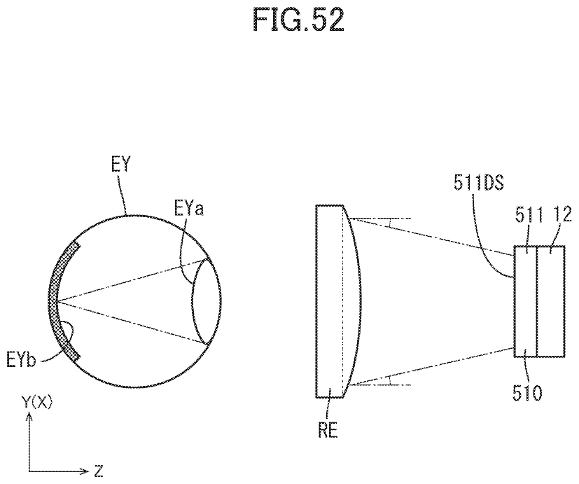

Embodiment 6 will be described with reference to FIGS. 52 to 54. In Embodiment 6, the optical design of the lens unit RE and the configuration of a first prism unit 523 are changed from Embodiment 1 described above. The duplicate description of the same structure, action, and effect as those in Embodiment 1 described above will be omitted.

As illustrated in FIG. 52, the lens unit RE according to the embodiment has an optical design in which the light that advances at an angle tilted inward (toward the center side in the X-axis direction and the Y-axis direction) with respect to the Z-axis direction which is the normal direction of a display surface 511DS of a liquid crystal panel 511 is captured, and angled so as to be oriented toward the eye of the user. Therefore, in the embodiment, it is preferable that the emitted light of the liquid crystal panel 511 is angled so as to be directed outward (the end side on the opposite side of the center side in the X-axis direction and the Y-axis direction) of the lens unit RE. There is a preferable numerical value for the angle formed by the light captured by the lens unit RE with respect to the Z-axis direction, and in the embodiment, the angle is, for example, approximately ±20°. In other words, the light that forms an angle of ±20° on the inside in the Z-axis direction is efficiently captured by the lens unit RE and efficiently reaches the eye of the user.

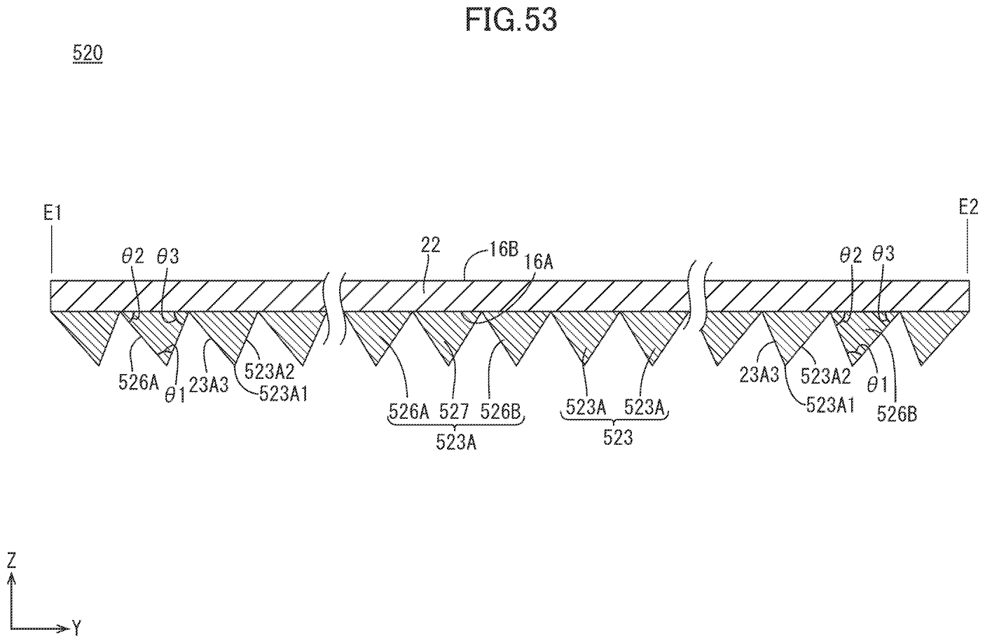

On the other hand, in the first prism unit 523 according to the embodiment, as illustrated in FIG. 53, first top portions 523A1 in a plurality of first top portion uneven distribution prisms 526 included in a plurality of first unit prisms 523A are configured to be unevenly distributed on the center side in the Y-axis direction in the first lens sheet 520. Specifically, in an LED-end-side first top portion uneven distribution prism 526A, the first top portions 523A1 are unevenly distributed on the center side in the Y-axis direction, and in an opposite-LED-end-side first top portion uneven distribution prism 526B, the first top portions 523A1 are unevenly distributed on the center side in the Y-axis direction. According to such a configuration, the light refracted by a main refraction slope 523A2 on the opposite LED end E2 side of each of the plurality of LED-end-side first top portion uneven distribution prisms 526A and the opposite-LED-end-side first top portion uneven distribution prisms 526B, advances so as to be directed outward (toward each end E1 and E2) in the Y-axis direction. Specifically, among the plurality of first top portion uneven distribution prisms 526, the light refracted by the main refraction slope 523A2 on the opposite LED end E2 side in the LED-end-side first top portion uneven distribution prism 526A arranged in the range from the center of the first lens sheet 520 in the Y-axis direction to the LED end E1, advances so as to be directed toward the LED end E1 side in the Y-axis direction. Meanwhile, among the plurality of first top portion uneven distribution prisms 526, the light refracted by the main refraction slope 523A2 on the opposite LED end E2 side in the opposite-LED-end-side first top portion uneven distribution prism 526B arranged in the range from the center of the first lens sheet 520 in the Y-axis direction to the opposite LED end E2, advances so as to be directed toward the opposite LED end E2 side in the Y-axis direction. In this manner, the light condensing action is imparted such that the emitted light of the first lens sheet 520 advances so as to be directed outward in the Y-axis direction by the first top portion uneven distribution prism 526, and thus, the design conforms to the optical design of the lens unit RE described above.

The base angles θ2 and θ3 in the first unit prism 523A will be described in detail. The top angle θ1 of the first unit prism 523A is fixed at 65°, similar to Embodiment 1 described above. A top portion non-uneven distribution prism 527 is the same as that of Embodiment 1 described above. In the plurality of LED-end-side first top portion uneven distribution prisms 526A included in the first top portion uneven distribution prism 526, the base angle θ2 on the LED end E1 side decreases as the position in the Y-axis direction approaches the LED end E1, and the base angle θ3 on the opposite LED end E2 side increases. Specifically, the minimum value of the base angle θ2 on the LED end E1 side of the LED-end-side first top portion uneven distribution prism 526A is 44°, and the maximum value of the base angle θ3 on the opposite LED end E2 side is 71°. On the other hand, in the plurality of opposite-LED-end-side first top portion uneven distribution prism 526B included in the first top portion uneven distribution prisms 526, the base angle θ2 on the LED end E1 side increases as the position in the Y-axis direction approaches the opposite LED end E2, and the base angle θ3 on the opposite LED end E2 side decreases. Specifically, the maximum value of the base angle θ2 on the LED end E1 side of the opposite-LED-end-side first top portion uneven distribution prism 526B is 70.4°, and the minimum value of the base angle θ3 on the opposite LED end E2 side is 44.6°. In other words, the maximum value (71°) of the base angle θ3 on the opposite LED end E2 side of the LED-end-side first top portion uneven distribution prism 526A is larger than the maximum value (70.4°) of the base angle θ2 on the LED end E1 side of the opposite-LED-end-side first top portion uneven distribution prism 526B, and the minimum value) (44° of the base angle θ2 on the LED end E1 side of the LED-end-side first top portion uneven distribution prism 526A is smaller than the minimum value (44.6°) of the base angle θ3 on the opposite LED end E2 side of the opposite-LED-end-side first top portion uneven distribution prism 526B. Here, in a case where the base angle of the top portion non-uneven distribution prism 527 is a reference value (57.5°) and the difference between the reference value and the base angle θ2 on the LED end E1 side of the first unit prism 523A is Δθ, while the maximum value of the difference Δθ in the LED-end-side first top portion uneven distribution prism 526A is −13.5°, the maximum value of the difference Δθ in the opposite-LED-end-side first top portion uneven distribution prism 526B is 12.9°.

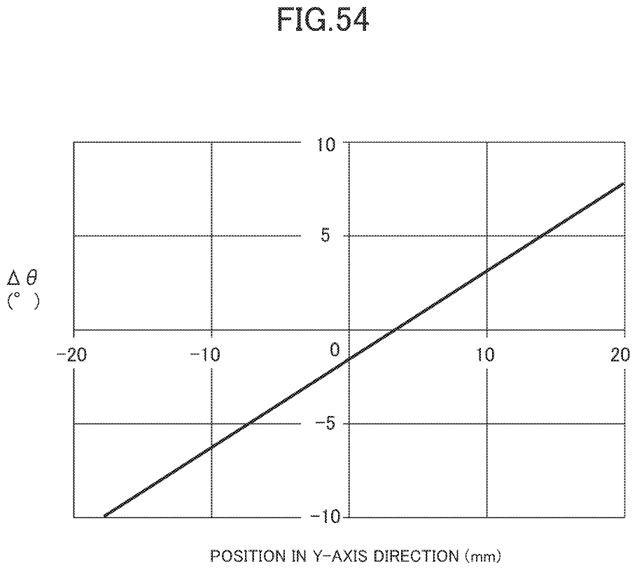

FIG. 54 illustrates a graph illustrating the relationship between the position of the first unit prism 523A in the Y-axis direction and the difference Δθ. The vertical axis and the horizontal axis in FIG. 54 are the same as those in FIG. 7 described in Embodiment 1 described above. According to the graph illustrated in FIG. 54, it can be seen that the difference Δθ changes linearly upward to the right depending on the position in the Y-axis direction. The intersection of the graph and the horizontal axis indicates the position of the top portion non-uneven distribution prism 527, and the position is indicated by a − sign. Therefore, it can be seen that the top portion non-uneven distribution prism 527 is positioned on the LED end E1 side of the center position (reference position) in the Y-axis direction of the first lens sheet 520. Along with this, when comparing the LED-end-side first top portion uneven distribution prism 526A and the opposite-LED-end-side first top portion uneven distribution prism 526B with each other having the same distance (the distance from the LED end E1 and the distance from the opposite LED end E2) from the top portion non-uneven distribution prism 527 in the Y-axis direction, the LED-end-side first top portion uneven distribution prism 526A has a larger absolute value of the difference Δθ than that of the opposite-LED-end-side first top portion uneven distribution prism 526B. The difference Δθ at the intersection of the graph and the vertical axis is “−0.3°”.

As described above, according to the embodiment, in the plurality of first top portion uneven distribution prisms 526, the first top portion 523A1 is unevenly distributed on the center side of the first lens sheet 520 in the normal direction. In this manner, among the plurality of first top portion uneven distribution prisms 526, the light refracted by the main refraction slope 523A2 on the opposite LED end E2 side in the first top portion uneven distribution prism 526 arranged in the range from the center of the first lens sheet 520 in the normal direction to the LED end E1, advances so as to be directed toward the LED end E1 side in the normal direction. Meanwhile, among the plurality of first top portion uneven distribution prisms 526, the light refracted by the main refraction slope 523A2 on the opposite LED end E2 side in the first top portion uneven distribution prism 526 arranged in the range from the center of the first lens sheet 520 in the normal direction to the opposite LED end E2, advances so as to be directed toward the opposite LED end E2 side in the normal direction.

### Embodiment 7

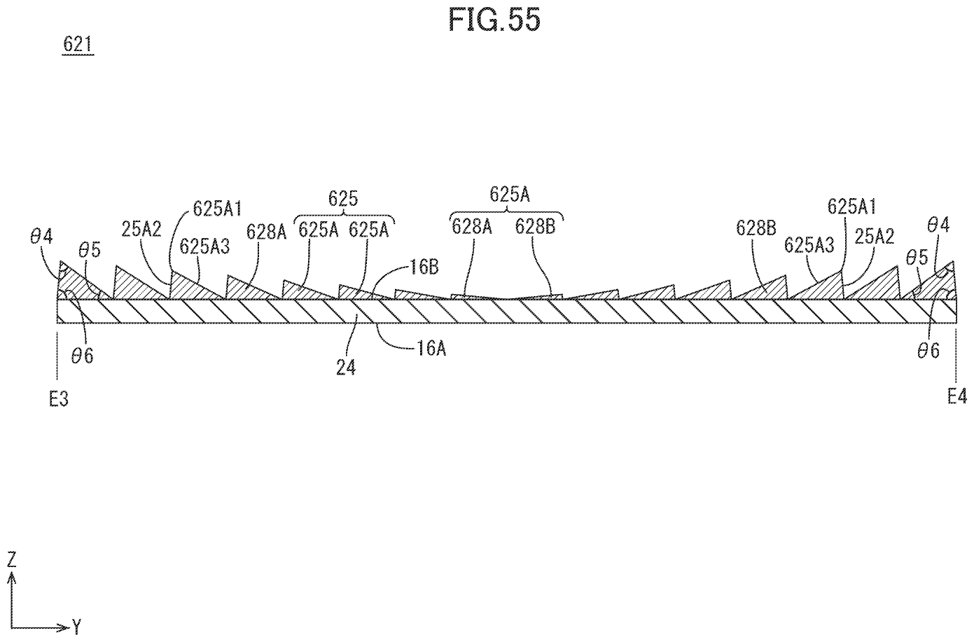

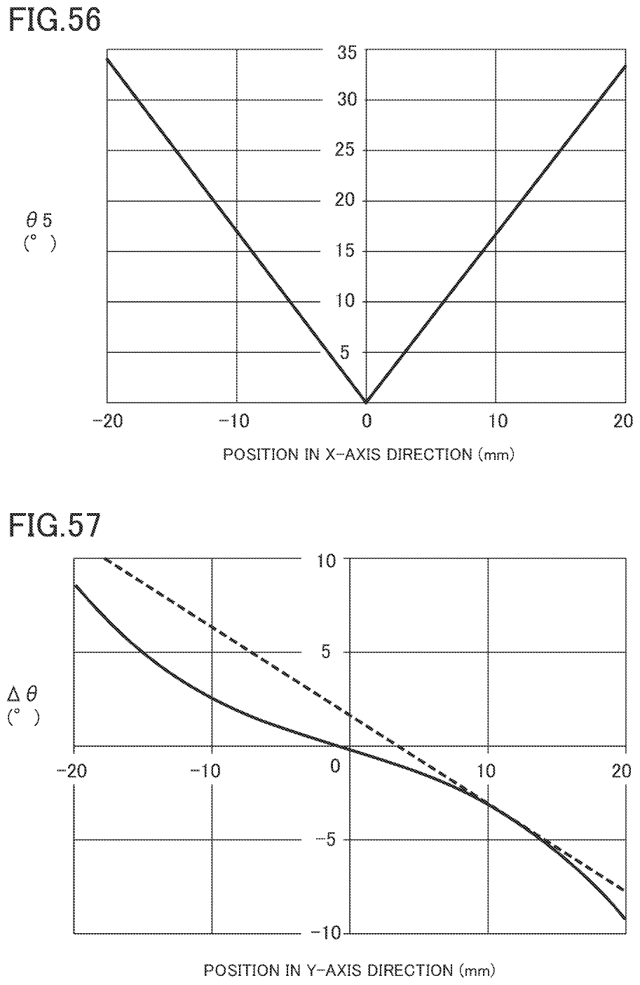

Embodiment 7 will be described with reference to FIG. 55 or 56. In Embodiment 7, the configuration of a second prism unit 625 is changed from Embodiment 6 described above. The duplicate description of the same structure, action, and effect as those in Embodiment 6 described above will be omitted.

In the second prism unit 625 according to the embodiment, as illustrated in FIG. 55, second top portions 625A1 in a plurality of second top portion uneven distribution prisms 628 included in a plurality of second unit prisms 625A are configured to be unevenly distributed on each end E3 and E4 side in the X-axis direction in a second lens sheet 621. Specifically, in one-end-side second top portion uneven distribution prism 628A, the second top portions 625A1 are unevenly distributed on one end E3 side in the X-axis direction, and in the-other-end-side second top portion uneven distribution prism 628B, the second top portions 625A1 are unevenly distributed on the other end E4 side in the X-axis direction. According to such a configuration, the light refracted by each second slope 625A3 on the center side of each of the plurality of one-end-side second top portion uneven distribution prisms 628A and the-other-end-side second top portion uneven distribution prisms 628B, advances so as to be directed outward (toward each end E3 and E4 side) in the X-axis direction. Specifically, among a plurality of second top portion uneven distribution prisms 626, the light refracted by the second slope 625A3 on the center side in the one-end-side second top portion uneven distribution prism 628A arranged in the range from the center of the second lens sheet 621 in the X-axis direction to one end E3, advances so as to be directed toward one end E3 side in the X-axis direction. Meanwhile, among the plurality of second top portion uneven distribution prisms 626, the light refracted by the second slope 625A3 on the center side in the-other-end-side second top portion uneven distribution prism 628B arranged in the range from the center of the second lens sheet 621 in the X-axis direction to the other end E4 side, advances so as to be directed toward the other end E4 side in the X-axis direction. As described above, the light condensing action is imparted such that the emitted light of the second lens sheet 621 advances so as to be directed outward in the X-axis direction by the second top portion uneven distribution prism 626, and thus, the design conforms to the optical design of the lens unit RE (refer to FIG. 52) described in Embodiment 6 described above.

The top angle θ4 and the base angle θ5 in the second unit prism 625A will be described in detail. In the embodiment, the base angle θ6 on each end E3 and E4 side of the second unit prism 625A is fixed at 85°. In the plurality of one-end-side second top portion uneven distribution prisms 628A, the base angle θ5 on the center side increases as the position in the X-axis direction approaches one end E3, and the top angle θ4 decreases. Specifically, while the maximum value of the base angle θ5 on the center side of the one-end-side second top portion uneven distribution prism 628A is 36° and the minimum value is 0.8°, the minimum value of the top angle θ4 is 59° and the maximum value is 94.2°. On the other hand, in the-other-end-side second top portion uneven distribution prisms 628B included in the plurality of second top portion uneven distribution prisms 628, the base angle θ5 on the center side increases as the position in the X-axis direction approaches the other end E4, and the top angle θ4 decreases. Specifically, while the maximum value of the base angle θ5 on the center side of the-other-end-side second top portion uneven distribution prism 628B is 38° and the minimum value is 0.8°, the minimum value of the top angle θ4 is 57° and the maximum value is 94.2°. In other words, the maximum value (36°) of the base angle θ5 on the center side of the one-end-side second top portion uneven distribution prism 628A is smaller than the maximum value) (38° of the base angle θ5 on the center side of the-other-end-side second top portion uneven distribution prism 628B, and the minimum value) (59° of the top angle θ4 on the one-end-side second top portion uneven distribution prism 628A is larger than the minimum value (57°) of the top angle θ4 on the-other-end-side second top portion uneven distribution prism 628B.

FIG. 56 illustrates a graph illustrating the relationship between the base angle θ5 on the center side of the second unit prism 625A and the position in the second unit prism 625A in the X-axis direction. The vertical axis and the horizontal axis in FIG. 56 are the same as those in FIG. 9 described in Embodiment 1 described above. According to the graph illustrated in FIG. 56, the base angle θ5 changes linearly depending on the position in the X-axis direction, and as approaching each end E3 and E4 side from the reference position in the X-axis direction, the base angle θ5 on the center side of each second unit prism 625A tends to increase. In the one-end-side second top portion uneven distribution prism 628A positioned on one end E3 side in the X-axis direction, as compared with the-other-end-side second top portion uneven distribution prism 628B positioned on the other end E4 side, the change rate of the base angle θ5 with respect to the position change in the X-axis direction decreases.

### Other Embodiments

The techniques disclosed in the present specification are not limited to the embodiments described above and in the drawings, and for example, the following embodiments are also included in the technical scope.

(1) As a modification example of Embodiment 1, it is also possible to linearly change the base angle θ2 on the LED end E1 side of the first unit prism 23A, and an example thereof is illustrated in FIG. 57. FIG. 57 is a graph illustrating the relationship between the position of the first unit prism 23A in the Y-axis direction and the difference Δθ between the reference value and the base angle θ2 on the LED end E1 side of the first unit prism 23A. The vertical axis and the horizontal axis in FIG. 57 are the same as those in FIG. 7. In FIG. 57, the graph of FIG. 7 is illustrated by a broken line for reference. According to the graph illustrated by a solid line in FIG. 57, it can be seen that the difference Δθ changes in a curved shape depending on the position in the Y-axis direction. In this manner, the plurality of first unit prisms 23A are configured such that the base angles θ2 and θ3 change linearly depending on the position in the normal direction.

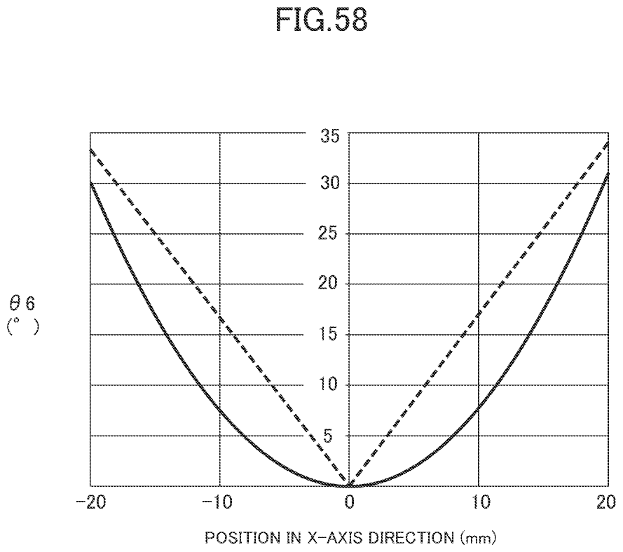

(2) As a modification example of Embodiment 1, it is also possible to non-linearly change the base angle θ6 on each end E3 and E4 side of the second unit prism 25A, and an example thereof is illustrated in FIG. 58. FIG. 58 is a graph illustrating the relationship between the position of the second unit prism 25A in the X-axis direction and the base angle θ6 on each end E3 and E4 side of the second unit prism 25A. The vertical axis and the horizontal axis in FIG. 58 are the same as those in FIG. 9. In FIG. 58, the graph of FIG. 9 is illustrated by a broken line for reference. According to the graph illustrated by a solid line in FIG. 58, it can be seen that the base angle θ6 on each end E3 and E4 side changes in a curved shape depending on the position in the Y-axis direction. In this manner, the plurality of second unit prisms 25A are configured such that, while one base angle θ5 of one pair of base angles θ5 and 06 is all the same, the other base angle θ6 changes in a curved shape depending on the position in the orthogonal direction.

(3) It is also possible to employ the contents described in (1) above to Embodiment 6.

(4) It is also possible to employ the contents described in (2) above to Embodiment 7.

(5) Specific numerical values related to the top angle θ1 and each of the base angles θ2 and θ3 of the first unit prisms 23A and 523A configuring the first prism units 23 and 523 of the first lens sheets 20, 320, 420, and 520 can be appropriately changed. The method of changing the base angle θ2 (difference Δθ) can be appropriately changed in addition to FIGS. 7, 54, and 57.

(6) Specific numerical values related to the top angle θ4 and each of the base angles θ5 and 06 of the second unit prisms 25A, 425A, and 625A configuring the second prism units 25, 425, and 625 in the second lens sheets 21, 421, and 621 can be appropriately changed. The method of changing the base angles θ5 and 06 can be appropriately changed in addition to FIGS. 9, 56, and 58.

(7) It is also possible to omit the light emitting plate surface lens units 17, 117, 217, and 317 in the light guide plates 15, 115, 215, and 315.

(8) It is also possible to provide the emitted-light reflection units 19 and 319 on the light emitting plate surfaces 15A, 115A, 215A, and 315A in the light guide plates 15, 115, 215, and 315.

(9) It is also possible to omit the emitted-light reflection units 19 and 319 in the light guide plates 15, 115, 215, and 315. In this case, a known dot pattern for promoting the emission of light may be formed on the light emitting opposite plate surfaces 15C and 315C of the light guide plates 15, 115, 215, and 315.

(10) The thickness of the light guide plates 15, 115, 215, and 315 may not have to be fixed over the entire length, and for example, a configuration may be employed in which the thickness of the light guide plates 15, 115, 215, and 315 decreases as moving away from the LED 13 and the light emitting opposite plate surfaces 15C and 315C are inclined.

(11) It is also possible to appropriately combine Embodiments 1 to 7.

(12) The planar shape of the liquid crystal display devices 10, 110, and 510 may be a square, a circle, an ellipse, a trapezoid, a rhombus, or the like, in addition to the rectangle.

(13) The LED 13 may be a top light emitting type as well as a side light emitting type.

(14) In addition to the liquid crystal panels 11 and 511, the disclosure can also be applied to the display device including a display panel (PDP (plasma display panel), an organic EL panel, an EPD (microcapsule type electrophoresis display panel), a MEMS (Micro Electro Mechanical Systems) display panel, or the like).

(15) In addition to the head-mounted display HMD, the disclosure can also be employed to, for example, a head-up display or a projector as a device for magnifying and displaying an image displayed on the liquid crystal panels 11 and 511 using a lens or the like. The disclosure can also be applied to the liquid crystal display devices 10, 110, and 510 (television reception device, tablet terminals, smartphones, and the like) that do not have an enlarged display function.

(16) The opposite-LED-end-side first top portion uneven distribution prisms 26B and 526B may be arranged to be positioned on the opposite LED end E2 side on the opposite side of the LED end E1 in the normal direction of the light entering end surfaces 15B and 215B such that the distance from the opposite LED end E2 is the same as the distance from the LED end E1 to the LED-end-side first top portion uneven distribution prisms 26A and 526A, and the uneven distribution amount of the top portions 23A1 and 523A1 may be larger than that of the LED-end-side first top portion uneven distribution prisms 26A and 526A.

The present disclosure contains subject matter related to that disclosed in Japanese Priority Patent Application JP 2020-049366 filed in the Japan Patent Office on Mar. 19, 2020, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a light source;
a light guide plate having a light entering end surface which is at least a part of an outer peripheral end surface and on which light from the light source is incident and a light emitting plate surface which is one of a pair of plate surfaces and emits light;
a display panel arranged so as to face the light emitting plate surface with respect to the light guide plate; and
a lens sheet that is arranged so as to be interposed between the light guide plate and the display panel and refracts the light emitted from the light emitting plate surface, wherein
the lens sheet has a prism unit arranged on a light entering surface facing the light emitting plate surface, and the prism unit has a plurality of unit prisms arranged along a normal direction of the light entering end surface, extending along the light emitting plate surface and along an orthogonal direction orthogonal to the normal direction, and having a top portion and a pair of slopes sandwiching the top portion, and
the plurality of unit prisms have at least a plurality of top portion uneven distribution prisms in which the top portions are unevenly distributed in the normal direction, and the plurality of top portion uneven distribution prisms have a light-source-end-side top portion uneven distribution prism positioned on a light source end side close to the light source in the normal direction and an opposite-light-source-end-side top portion uneven distribution prism which is positioned on an opposite light source end side on an opposite side of a light source end in the normal direction, is arranged such that a distance from an opposite light source end is the same as a distance from the light source end to the light-source-end-side top portion uneven distribution prism, and has a different uneven distribution amount of the top portions from that of the light-source-end-side top portion uneven distribution prism.

2. The display device according to claim 1, wherein
the plurality of unit prisms have the same top angle at the top portion.

3. The display device according to claim 2, wherein
the plurality of unit prisms are configured such that a base angle changes linearly depending on a position in the normal direction.

4. The display device according to claim 2, wherein
the plurality of unit prisms are configured such that a base angle changes in a curved shape depending on a position in the normal direction.

5. The display device according to claim 1, further comprising:
a second lens sheet arranged so as to be interposed between the lens sheet and the display panel, wherein
the second lens sheet has a second prism unit arranged on any one of the plate surfaces, the second prism unit has a plurality of second unit prisms arranged along the orthogonal direction, extending along the normal direction, and having a second top portion and a pair of second slopes sandwiching the second top portion, the plurality of second unit prisms have at least a plurality of second top portion uneven distribution prisms in which the second top portions are unevenly distributed in the orthogonal direction, and the plurality of second top portion uneven distribution prisms have a one-end-side top portion uneven distribution prism positioned on one end side in the orthogonal direction and a the-other-end-side top portion uneven distribution prism which is positioned on the other end side in the orthogonal direction, is arranged such that a distance from the other end is the same as a distance from the one end to the one-end-side top portion uneven distribution prism, and has a different uneven distribution amount of the second top portion from that of the one-end-side top portion uneven distribution prism.

6. The display device according to claim 5, wherein
the second prism unit is arranged on the plate surface on an opposite side of a side facing the lens sheet, of the plate surface of the second lens sheet, and
in the lens sheet and the second lens sheet, plate surfaces facing each other are respectively roughened.

7. The display device according to claim 6, wherein
a surface roughness of the plate surface facing the lens sheet in the second lens sheet is smaller than a surface roughness of the plate surface facing the second lens sheet in the lens sheet.

8. The display device according to claim 5, wherein
the second prism unit is arranged on the plate surface facing the lens sheet, of the plate surfaces of the second lens sheet.

9. The display device according to claim 5, wherein
the plurality of second unit prisms are configured such that, while one base angle of one pair of base angles is all the same, the other base angle changes linearly depending on the position in the orthogonal direction.

10. The display device according to claim 5, wherein
the plurality of second unit prisms are configured such that, while one base angle of one pair of base angles is all the same, the other base angle changes in a curved shape depending on the position in the orthogonal direction.

11. The display device according to claim 1, wherein
while a plurality of the light-source-end-side top portion uneven distribution prisms are arranged in a range from a center of the lens sheet in the normal direction to the light source end and the top portions are unevenly distributed on the light source end side in the normal direction, a plurality of the opposite-light-source-end-side top portion uneven distribution prisms are arranged in a range from the center of the lens sheet in the normal direction to the opposite light source end, and the top portions are unevenly distributed on the opposite light source end side in the normal direction.

12. The display device according to claim 1, wherein
in the plurality of top portion uneven distribution prisms, the top portions are unevenly distributed on a center side of the lens sheet in the normal direction.

13. The display device according to claim 1, wherein
the light guide plate has a light emitting plate surface lens unit provided on the light emitting plate surface, and the light emitting plate surface lens unit has a plurality of light emitting plate surface unit lenses extending along the normal direction and arranged along the orthogonal direction.

14. The display device according to claim 13, wherein
the light emitting plate surface lens unit is a light emitting plate surface lenticular lens in which the plurality of light emitting plate surface unit lenses are configured with a plurality of light emitting plate surface cylindrical lenses.

15. The display device according to claim 13, wherein
the light emitting plate surface lens unit is a light emitting plate surface prism in which the plurality of light emitting plate surface unit lenses are configured with a plurality of light emitting plate surface unit prisms.

16. The display device according to claim 13, wherein
the light emitting plate surface lens unit is a compound lens in which the plurality of light emitting plate surface unit lenses are configured with a plurality of light emitting plate surface cylindrical lenses and a plurality of light emitting plate surface unit prisms, and
in the compound lens, regarding an occupancy ratio in the orthogonal direction on the light emitting plate surface, the light emitting plate surface cylindrical lens and the light emitting plate surface unit prism are provided such that, while the occupancy ratio of the light emitting plate surface unit prism is relatively low and the occupancy ratio of the light emitting plate surface cylindrical lens is relatively high on a side close to the light entering end surface in the normal direction, the occupancy ratio of the light emitting plate surface unit prism is relatively high and the occupancy ratio of the light emitting plate surface cylindrical lens is relatively low on a side far from the light entering end surface in the normal direction.

17. The display device according to claim 13, wherein
the light guide plate has a light emitting opposite plate surface lens unit provided on a light emitting opposite plate surface which is a plate surface on an opposite side of the light emitting plate surface, and
the light emitting opposite plate surface lens unit has a plurality of light emitting opposite plate surface unit lenses extending along the normal direction and arranged at intervals along the orthogonal direction.

18. The display device according to claim 17, wherein
the light guide plate has an emitted-light reflection unit provided on the light emitting opposite plate surface,
the emitted-light reflection unit has a plurality of unit reflection units extending along the orthogonal direction and arranged at intervals along the normal direction, and
the light emitting opposite plate surface lens unit is formed such that the light emitting opposite plate surface unit lens protrudes outward from the unit reflection unit.

19. A head-mounted display comprising:
the display device according to claim 1;
a lens unit that forms an image displayed on the display device on an eye of a user; and
a head-mounted device having the display device and the lens unit and mounted on a head of the user.
